(19) United States
(12) Patent Application Publication
(10) Pub. No.: US 2024/0014657 A1
(43) Pub. Date: Jan. 11, 2024

(54) METHOD AND SOFTWARE TO AID IN CREATING DISPATCH PROFILES OF ENERGY STORAGE SYSTEMS AND TO MODEL PERFORMANCE OF ENERGY STORAGE SYSTEMS

(71) Applicants: Sherif Abdelrazek, Charlotte, NC (US); Shekih Jakir Hossain, Harrisburg, NC (US)

(72) Inventors: Sherif Abdelrazek, Charlotte, NC (US); Shekih Jakir Hossain, Harrisburg, NC (US)

(21) Appl. No.: 18/216,694

(22) Filed: Jun. 30, 2023

Related U.S. Application Data
(60) Provisional application No. 63/359,026, filed on Jul. 7, 2022.

(51) Int. Cl. H02J 3/32

(52) U.S. Cl. CPC H02J 3/32

(57) ABSTRACT

A method or software is designed and configured to aid in creating dispatch profiles of energy storage systems (ESS), and/or to model performance of energy storage systems. The method or software generally includes providing a computer-readable software platform configured to store instructions that, when executed by a computer, cause the software platform to provide an ESS profile creator module or PCM and/or an energy storage system defined system module or DSM. The PCM is configured to develop ESS dispatch profiles for multiple utility, commercial and industrial, and residential applications use cases (ES Apps). The DSM is configured to allow a user to deduce performance metrics for a user-defined ESS by executing a user-defined POI Profile deduced by the user or developed through the profile creator module. Wherein, the DSM is configured to deduce parameters that allow the user to optimize the design of the ESS for a specific ES App.

### CROSS-REFERENCE To RELATED APPLICATIONS

This application claims benefit to U.S. Provisional Patent Application No. 63/359,026. filed on Jul. 7, 2022, entitled “SOFTWARE TO AID CREATING ENERGY STORAGE SYSTEMS′ DISPATCH PROFILES AND MODEL ENERGY STORAGE SYSTEMS' PERFORMANCE”, which is incorporated by reference in its entirety.

### FIELD OF THE DISCLOSURE

The present disclosure relates to energy storage systems. More specifically, the present disclosure relates to software to aid in creating dispatch profiles for energy storage systems and to model performance of energy storage systems.

### BACKGROUND

Generally speaking, energy storage is the capture of energy produced at one time for use at a later time to reduce imbalances between energy demand and energy production. A device that stores energy is generally called an accumulator or battery. Energy comes in multiple forms including radiation, chemical, gravitational potential, electrical potential, electricity, elevated temperature, latent heat and kinetic. Energy storage involves converting energy from forms that are difficult to store to more conveniently or economically storable forms. Some technologies provide short-term energy storage, while others can endure for much longer. Grid energy storage is a collection of methods used for energy storage on a large scale within an electrical power grid.

The disclosed software may be used for designing and sizing grid-tied and islanded energy storage systems. Grid-tied energy storage systems are connected to the local power grid, like a municipalities power grid or power companies power grid. Grid-tied energy storage systems are typically capable of pulling power from the local power grid, as needed, and selling power back to the power grid when it is needed. On the other hand, islanded energy storage systems are not tied to the power grid and are isolated to the energy storage system. One example of energy storage is the rechargeable battery, which stores chemical energy readily convertible to electricity. Grid-connected batteries come in a variety of technologies and chemical compositions. Currently, the most common is lithium-ion batteries, such as Tesla Powerwall, Sonnen Eco, and Enphase AC. They are able to store power, like from a solar arrays, and to supplement power needs, like overnight or during periods of inclement weather.

The installation of an energy storage system is vital for the microgrid islanded operation to ensure the maintenance of demand—supply balance. Lithium-ion batteries are among the most commonly used energy storage system technologies for grid-based applications as well as islanded applications. Lithium-ion batteries are ideal to constantly maintain the demand—supply balance in a residential microgrid.

The instant disclosure recognizes the problems associated with designing such grid tied and islanded energy storage systems. Namely, different energy storage system components, including batteries, inverters, converters, etc., from different manufactures have various energy storage system performance characteristics including, but not limited to, degradation, round-trip efficiency, losses, and auxiliary load requirements based on user inputted dispatch profiles, depth of discharge, C-rate, average state of charge, center state of charge, calendar life, ambient temperature, energy losses and round-trip efficiency during operation, considering ambient temperature, C-rate, battery cell specifications, type of cooling systems, project region, dispatch profile, the like, etc. As such, it is very difficult if not impossible to know which energy storage system components and energy storage system profile is ideal for the needs of each energy storage system use case. As such, developers and designers of energy storage systems are unable to accurately predict how energy storage systems will degrade prior to procurement from energy storage system (ESS) original equipment manufactures (OEMs) (well after the design phase). In addition, energy storage system developers are unable to compare the performance of different energy storage technologies (and OEMs) during the design phase of grid-tied and islanded energy storage systems. Furthermore, there are no existing standard file formats for energy storage mediums (like batteries, flywheels, compressed air, flow batteries, metal air, etc.) models. Additionally, energy storage system developers must write lengthy code or spend hours writing excel formulas to produce energy storage system dispatch profiles for different grid-tied and islanded systems' use-cases. Furthermore, stacking and prioritizing different energy storage use-cases is extremely complex and there are no tools available to aid energy storage developers and designers to do this. Thus, there is clearly a need to provide a means or mechanism for aiding in the creation and modeling of energy storage systems for project financial modeling and cost estimations.

The instant disclosure may be designed to address at least certain aspects of the problems or needs discussed above by providing software to aid in creating dispatch profiles of energy storage systems, and/or to model performance of energy storage systems.

### SUMMARY

The present disclosure may solve the aforementioned limitations of the currently available means or mechanisms for creating and modeling energy storage systems, by providing a method or software to aid in creating dispatch profiles of energy storage systems, and/or to model performance of energy storage systems. The disclosed software or software platform may be designed and configured to aid in creating dispatch profiles of energy storage systems, and/or to model performance of energy storage systems and may generally include providing a computer-readable software platform configured to store instructions that, when executed by a computer, cause the software platform to provide an energy storage system profile creator module or PCM and/or an energy storage system defined system module or DSM. The energy storage system profile creator module (PCM) may be configured to develop energy storage system dispatch profiles for multiple utility, commercial and industrial (C&I), and residential applications use cases (ES Apps). The energy storage system defined system module (DSM) may be configured to allow a user to deduce performance metrics for a user-defined Energy Storage System (ESS) by executing a user-defined point of interconnection (POI) Profile deduced by the user or developed through the profile creator module, wherein the defined system module is configured to deduce parameters that allow the user to optimize the design of the energy storage system for a specific ES App.

In select embodiments of the disclosed method or software configured to aid in creating dispatch profiles of energy storage systems, and/or to model performance of energy storage systems, the software platform may provide the profile creator module, and the defined system module. Wherein, when the software platform starts, the user can select either a PCM tab to view and interact with a PCM interface of the profile creator module, or a DSM tab to view and interact with a DSM interface of the defined system module.

In select embodiments of the disclosed method or software configured to aid in creating dispatch profiles of energy storage systems, and/or to model performance of energy storage systems, the profile creator module may include PCM User inputs, a PCM Solution Development component, and a PCM Results Creation component. In select embodiments, the PCM User inputs may be configured to allow the user to select and specify: a Dispatch Mode; the ES Apps; a Simulation Time-step, duration and input profile templates to create; input profiles for selected ES Apps; ES App parameter values for each selected ES App; a PCM Run Mode of a single run or a group run; and/or an option to use Deduced POI Profiles as input for DSM or not. In select embodiments, the PCM Solution Development component may be designed and configured to: allow the user to click a Run button; check for errors in the PCM User Inputs, wherein if an error exists, the PCM Solution Development component is configured to alert the user to fix, and wherein if no errors exist, the PCM Solution Development component is configured to continue; analyze the PCM user inputs; optimize an ESS Profile based on the PCM User Inputs; deduce a PCM Solution Data Set, and activate a Generate Report button, and a Generate Output CSVs button (comma separated values button); and/or if the user opted to use the POI Profile Deduced from the profile creator module in the defined system module, create a POI profile file in an input directory for the defined system module. In select embodiments, the PCM Results Creation component may be configured to: allow the user to click a Generate Report button; create PCM Report files in PDF format and save the PCM Report files in a user specified location; open the created PCM Report files for user to visualize; allow the user to click Generate Output CSVs button; and/or create PCM CSV files in CSV format and save the created PCM CSV files in a user specified location.

In select embodiments of the disclosed method or software configured to aid in creating dispatch profiles of energy storage systems, and/or to model performance of energy storage systems, the energy storage system dispatch profiles developed by the profile creator module may include, but are not limited to, Peak Load Shaving, Energy Arbitrage, Schedule Based Dispatch, Demand Charge Management, Renewables Smoothing, Renewables Firming, DC/AC Renewables Clipped/Curtailed Energy Storage, Daily Discharge & Charge Energy Equalization, Islanding Energy and Capacity Management, and Microgrid Operation.

One feature of the disclosed method or software configured to aid in creating dispatch profiles of energy storage systems, and/or to model performance of energy storage systems may be that the profile creator module may include a PCM interface configured to allow the user to input PCM user inputs specific to multiple ES Apps. In select embodiments, the PCM user inputs may include, but are not limited to, a set of PCM parameters and CSV files.

In select embodiments of the disclosed method or software configured to aid in creating dispatch profiles of energy storage systems, and/or to model performance of energy storage systems, the profile creator module may include a run button configured to simulate the performance of selected ES Apps. In select embodiments, the profile creator module may be configured to produce, but is not limited to, an ESS dispatch profile, reports, and analytics that reflect user inputs. In select embodiments, the produced dispatch profile may be configured to be used as an input to the defined system module.

Another feature of the disclosed method or software configured to aid in creating dispatch profiles of energy storage systems, and/or to model performance of energy storage systems may be that the profile creator module may be configured to allow the user to specify within the software platform how different ES Apps interact with each other by allowing them to be prioritized, stacked, or interact in another user-defined or pre-set method. Wherein, in select embodiments, the profile creator module may be configured to allow the user to set a user defined timestep and a duration for a simulation and for output results. Wherein, based on the user defined timestep and the duration of the simulation, in select embodiments, the profile creator module may be configured to produce template interval data CSV files configured to allow the user to input a dataset to be used with selected ES Apps. Whereby, using these templates, the user can input load, as examples, and clearly not limited thereto, photovoltaic (PV), wind, thermal plant, hydro-plant or other time-interval profiles and set PCM User Inputs to control how the energy storage dispatch profile will be deduced within the software based on this interval data.

Another feature of the disclosed method or software configured to aid in creating dispatch profiles of energy storage systems, and/or to model performance of energy storage systems may be that once the user is satisfied with files and data inputted, the profile creator module may be configured to either run in a single run mode configured for if the user wanted to simulate only one case, or a group run mode configured for if the user wanted to run a group of simulations to find the optimal result. Wherein, in select embodiments, the user can opt to use a created dispatch profile as the input to the defined system module.

Another feature of the disclosed method or software configured to aid in creating dispatch profiles of energy storage systems, and/or to model performance of energy storage systems may be that after running the simulation, the profile creator module may be configured to create reports, graphs, tables, and CSV files that may reflect the solution and all associated analytics. Wherein, the profile creator module may also be configured to customize graphs, tables and analytical results that appear in the reports created.

In select embodiments of the disclosed method or software configured to aid in creating dispatch profiles of energy storage systems, and/or to model performance of energy storage systems, the defined system module may include DSM User Inputs, a DSM Simulation component, and a DSM Results Creation component. In select embodiments, the DSM User Inputs may be configured to allow the user to select and specify: a POI Profile, which is either user developed or output from the profile creator module; a Typical Meteorological Year (TMY) data file in (*.csv) format, which is either user developed or sourced from a third-party; to create new or edit existing equipment models using a component editor; equipment models for a user defined system (UDS); system specifications for the UDS, the system specifications including equipment count, and architecture; a sizing assist continuously updates and shows UDS parameters and compares with those needed by the POI profile; ESS Operational Parameters; ESS Degradation Estimation Assumptions for the UDS; and/or a DSM Run Mode including a single run or a group run. In select embodiments, the DSM Simulation component may be designed and configured to: allow the user to click a Run button; check for errors in the DSM User inputs or incompatibilities in the UDS, wherein, if any errors exist, the DSM Solution Development component is configured to alert the user to fix, and wherein if no errors exist, the DSM Solution Development component is configured to continue; analyzes the DSM User Inputs; deduce all ESS States during execution of the POI Profile with the UDS; and/or deduce a DSM Solution Data Set, and activates the Generate Report and the Generate Output CSVs buttons. In select embodiments, the DSM Results Creation component may be designed and configured to: allow the user to click the Generate Report button; create DSM Report files in PDF format and saves the DSM Report files in the user specified location; open created DSM Report files for the user to visualize; allow the user to click the Generate Output CSVs button; and/or create DSM CSV files in CSV format and saves the DSM CSV files in the user specified location.

In select embodiments of the disclosed method or software configured to aid in creating dispatch profiles of energy storage systems, and/or to model performance of energy storage systems, the parameters deduced by the defined system module may include, but are not limited to, system energy losses, efficiency, battery degradation estimates, throughput, depth of discharge, C-rate, average State of Charge (SoC), and many other parameters that allow the user to optimize the design of the energy storage system for specific ES Apps.

Another feature of the disclosed method or software configured to aid in creating dispatch profiles of energy storage systems, and/or to model performance of energy storage systems may be that the defined system module may include a DSM interface configured to allow the user to input user inputs that describe a user specified energy storage system and how it will be operated. In select embodiments, the user inputs may include, but are not limited to, a set of parameters and files.

Another feature of the disclosed method or software configured to aid in creating dispatch profiles of energy storage systems, and/or to model performance of energy storage systems may be that the defined system module may be configured to allow the user to input the user defined POI Profile that represents how the energy storage system will be dispatched controlled. In select embodiments, the user defined POI Profile may be developed within the profile creator module. In other select embodiments, the user defined POI Profile may be self-deduced by the user.

Another feature of the disclosed method or software configured to aid in creating dispatch profiles of energy storage systems, and/or to model performance of energy storage systems may be that the defined system module may be configured to allow the user to input the user defined TMY file that represents the meteorological conditions of the location at which the ESS is planned to be installed. In select embodiments, the user defined TMY file may be developed by the user. In other select embodiments, the TMY file may be sourced from a third party.

Another feature of the disclosed method or software configured to aid in creating dispatch profiles of energy storage systems, and/or to model performance of energy storage systems may be that the defined system module may be configured to allow the user to select models of equipment that will be utilized in the energy storage system. Wherein, in select embodiments, the models of equipment can be selected from a library of default models provided within the defined system module. Or, in other select embodiments, the models of equipment can be created by the user using a software Component Editor.

In select embodiments of the disclosed method or software configured to aid in creating dispatch profiles of energy storage systems, and/or to model performance of energy storage systems, the models of equipment configured to be selected by the defined system module may include, but are not limited to, energy storage mediums, batteries, inverters, converters, transformers, cables, energy storage enclosures, the like, etc.

Another feature of the disclosed method or software configured to aid in creating dispatch profiles of energy storage systems, and/or to model performance of energy storage systems may be that after selecting the models of equipment, the defined system module may be configured to allow the user to define, as examples, and clearly not limited thereto, specifications, architecture and topology of the energy storage system. Wherein, as the user defines the specifications, the architecture and the topology, in select embodiments a sizing assist tool may be configured to show the user how the energy storage system specified compares in capacity, energy, voltage, power, and current to the requirements of the user defined POI Profile. Wherein, in select embodiments, the sizing assist tool may be configured to show the user compatibility of devices specified or lack thereof. Wherein, in select embodiments, the defined system module may also be configured to allow the user to specify operational requirements of the contemplated energy storage system and state of health and degradation parameters to be assumed in the simulation.

Another feature of the disclosed method or software configured to aid in creating dispatch profiles of energy storage systems, and/or to model performance of energy storage systems may be that the defined system module may be configured to allow the user to run the simulation to deduce critical information about the performance of the user defined system. Wherein, in select embodiments, the defined system module may be configured to allow the user to run the simulation in a single run mode configured to simulate only one case, or to allow the user to run the simulation in a group run mode configured to run a group of simulations to find an optimal result. Wherein, after running the simulation, the defined system module may be configured to allow the user to create, as examples, and clearly not limited thereto, reports, graphs, tables and CSV files that reflect the solution. Wherein, the defined system module may be configured to create graphs, tables, and analytical results to appear in the reports created.

Another feature of the disclosed method or software configured to aid in creating dispatch profiles of energy storage systems, and/or to model performance of energy storage systems may be that the software platform may be configured to introduce a (*.btt) file format for modeling energy storage technologies. The (*.btt) file format may be configured to allow users to accurately compare performance of different energy storage technologies running different applications, thereby allowing the user to select the most appropriate technology for their use-case and optimize designs.

Another feature of the disclosed method or software configured to aid in creating dispatch profiles of energy storage systems, and/or to model performance of energy storage systems may be that the software platform may be configured to introduce a (*.inv) file format for modeling energy storage inverters. The (*.inv) file format may be configured to allow users to accurately compare performance of different inverter products, thereby leading to optimal equipment selection for user designs.

Another feature of the disclosed method or software configured to aid in creating dispatch profiles of energy storage systems, and/or to model performance of energy storage systems may be that the software platform is configured to introduce a (*.cnv) file format for modeling energy storage DC/DC converters. The (*.cnv) file format may be configured to allow users to accurately compare performance of different converter products, thereby leading to optimal equipment selection for user designs.

In select embodiments of the disclosed method or software configured to aid in creating dispatch profiles of energy storage systems, and/or to model performance of energy storage systems, the software platform may be configured to introduce a (*.btt) file format for modeling energy storage technologies, a (*.inv) file format for modeling energy storage inverters, and a (*.cnv) file format for modeling energy storage DC/DC converters. The (*.btt) file format may be configured to allow users to accurately compare performance of different energy storage technologies running different applications, thereby allowing the user to select the most appropriate technology for their use-case and optimize designs. The (*.inv) file format may be configured to allow users to accurately compare performance of different inverter products, thereby leading to optimal equipment selection for user designs. And the (*.cnv) file format may be configured to allow users to accurately compare performance of different converter products, thereby leading to optimal equipment selection for user designs.

Another feature of the disclosed method or software configured to aid in creating dispatch profiles of energy storage systems, and/or to model performance of energy storage systems may be that the software platform may be designed and configured to aid and simplify the process of designing and sizing grid-tied and islanded energy storage systems.

Another feature of the disclosed method or software configured to aid in creating dispatch profiles of energy storage systems, and/or to model performance of energy storage systems may be that the software platform may be designed and configured to allow users to easily deduce energy storage systems dispatch profiles POI profiles and simulate the performance of UDSs by executing the user defined POI profiles.

Another feature of the disclosed method or software configured to aid in creating dispatch profiles of energy storage systems, and/or to model performance of energy storage systems may be that the software platform may be designed and configured to allow accurate estimation of energy storage system performance characteristics including, but not limited to, degradation, round-trip efficiency, losses, and auxiliary load requirements based on user inputted dispatch profiles, or ones developed within the software platform.

Another feature of the disclosed method or software configured to aid in creating dispatch profiles of energy storage systems, and/or to model performance of energy storage systems may be that the software platform may be designed and configured to allow users to create models that accurately reflect the performance of OEM battery products when simulated inside the software platform.

Another feature of the disclosed method or software configured to aid in creating dispatch profiles of energy storage systems, and/or to model performance of energy storage systems may be that the software platform may be designed and configured to allow users to create models that accurately reflect the performance of OEM bi-directional inverter products when simulated inside the software platform.

Another feature of the disclosed method or software configured to aid in creating dispatch profiles of energy storage systems, and/or to model performance of energy storage systems may be that the software platform may be designed and configured to allow users to create models that accurately reflect the performance of OEM DC/DC converter products when simulated inside the software platform.

Another feature of the disclosed method or software configured to aid in creating dispatch profiles of energy storage systems, and/or to model performance of energy storage systems may be that the software platform may be designed and configured to allow users to accurately predict how energy storage systems will degrade prior to procurement from ESS OEMs (which may occur well after the design phase).

Another feature of the disclosed method or software configured to aid in creating dispatch profiles of energy storage systems, and/or to model performance of energy storage systems may be that the software platform may be designed and configured to allow users to compare between the performance of different Energy Storage (ES) technologies running the users specific application/use-case, which allows the user to select the most suitable Energy Storage Medium for their specific use-case. This leads to minimizing project cost and maximizing ESS life.

Another feature of the disclosed method or software configured to aid in creating dispatch profiles of energy storage systems, and/or to model performance of energy storage systems may be that the software platform may be designed and configured to allow users to accurately deduce performance characteristics of Energy Storage (ES) technologies very early in the conception and design phase of grid-tied and islanded ES systems, which results in more accurate estimation of capital and operating cost of conceptualized battery system.

Another feature of the disclosed method or software configured to aid in creating dispatch profiles of energy storage systems, and/or to model performance of energy storage systems may be that the software platform may be designed and configured to provide a standard model file format for Energy Storage Mediums (like batteries, flywheels, compressed air, flow batteries, metal air, etc.) that enables users to compare utilization of different ESMs for their projects.

Another feature of the disclosed method or software configured to aid in creating dispatch profiles of energy storage systems, and/or to model performance of energy storage systems may be that the software platform may be designed and configured to allow users to easily deduce ESS dispatch profiles for different grid-tied and islanded systems' use-cases/applications, thereby preventing the user from needing to write lengthy code or spend hours writing excel formulas.

Another feature of the disclosed method or software configured to aid in creating dispatch profiles of energy storage systems, and/or to model performance of energy storage systems may be that the software platform may be designed and configured to allow users to produce ESS dispatch profiles with multiple use-cases/applications stacked or prioritized based on user requirements, thereby enabling the user to use one ESS for more than one function leading to optimizing performance and maximizing financial revenue of designed energy storage projects.

Another feature of the disclosed method or software configured to aid in creating dispatch profiles of energy storage systems, and/or to model performance of energy storage systems may be that the software platform may be designed and configured to allow users to model ESSs, simulate their performance and create dispatch profiles at variable interval data time-steps, thereby allowing the user to simulate ESS operation executing dispatch profiles with different time-steps, allowing much needed flexibility in the energy storage system design process, allowing interval data time-step to be as short as one (1) second.

Another feature of the disclosed method or software configured to aid in creating dispatch profiles of energy storage systems, and/or to model performance of energy storage systems may be that the software platform may be designed and configured to allow users to model energy storage systems, simulate their performance and create dispatch profiles at extremely high fidelity, thereby allowing time-steps to be as short as one (1) second, wherein the method may be configured to allow the produced results to be of the highest accuracy reflecting real energy storage system performance.

Another feature of the disclosed method or software configured to aid in creating dispatch profiles of energy storage systems, and/or to model performance of energy storage systems may be that the software platform may be designed and configured to accurately estimate lithium and non-lithium battery technologies degradation throughout project life, considering impacts of Depth of Discharge, C-rate, Average State of Charge, Center State of Charge, Calendar Life, Ambient temperature, amongst other factors separately. This allows users to optimize use-cases and performance.

Another feature of the disclosed method or software configured to aid in creating dispatch profiles of energy storage systems, and/or to model performance of energy storage systems may be that the software platform may be designed and configured to accurately model energy storage projects' energy losses and round-trip efficiency during operation, considering ambient temperature, C-rate, battery cell specifications, type of cooling systems, project region, dispatch profile and other factors.

Another feature of the disclosed method or software configured to aid in creating dispatch profiles of energy storage systems, and/or to model performance of energy storage systems may be that the software platform may be designed and configured to allow the user full flexibility in the energy storage design process by simplifying development of energy storage systems dispatch profiles and allowing the user to use these profiles directly to model the performance of the actual system.

In another aspect, the instant disclosure embraces a method to aid in creating dispatch profiles for energy storage systems. The disclosed method to aid in creating dispatch profiles for energy storage systems may generally include providing a computer-readable software platform configured to store instructions that, when executed by a computer, cause the software platform to provide an energy storage system profile creator module (PCM). The profile creator module created by the software platform may be the profile creator module in any of the embodiments and/or combination of embodiments shown and/or described herein. Thus, the profile creator module may generally be configured to develop energy storage system dispatch profiles for multiple utility, commercial and industrial (C&I), and residential applications use cases (ES Apps).

In select embodiments of the disclosed method or software configured to aid in creating dispatch profiles of energy storage systems, the profile creator module may include PCM User inputs, a PCM Solution Development component, and a PCM Results Creation component. In select embodiments, the PCM User inputs may be configured to allow the user to select and specify: a Dispatch Mode; the ES Apps; a Simulation Time-step, duration and input profile templates to create; input profiles for selected ES Apps; ES App parameter values for each selected ES App; a PCM Run Mode of a single run or a group run; and/or an option to use Deduced POI Profiles as input for DSM or not. In select embodiments, the PCM Solution Development component may be designed and configured to: allow the user to click a Run button; check for errors in the PCM User Inputs, wherein if an error exists, the PCM Solution Development component is configured to alert the user to fix, and wherein if no errors exist, the PCM Solution Development component is configured to continue; analyze the PCM user inputs; optimize an ESS Profile based on the PCM User Inputs; deduce a PCM Solution Data Set, and activate a Generate Report button, and a Generate Output CSVs button; and/or if the user opted to use the POI Profile Deduced from the profile creator module in the defined system module, create a POI profile file in an input directory for the defined system module. In select embodiments, the PCM Results Creation component may be configured to: allow the user to click a Generate Report button; create PCM Report files in PDF format and save the PCM Report files in a user specified location; open the created PCM Report files for user to visualize; allow the user to click Generate Output CSVs button; and/or create PCM CSV files in CSV format and save the created PCM CSV files in a user specified location.

One feature of the disclosed method to aid in creating dispatch profiles for energy storage systems may be that the energy storage system dispatch profiles developed by the profile creator module may include, but are not limited to, Peak Load Shaving, Energy Arbitrage, Schedule Based Dispatch, Demand Charge Management, Renewables Smoothing, Renewables Firming, DC/AC Renewables Clipped/Curtailed Energy Storage, Daily Discharge & Charge Energy Equalization, Islanding Energy and Capacity Management, and Microgrid Operation. Wherein, in select embodiments, the PCM user inputs may include, but are not limited to, a set of PCM parameters and CSV files. The profile creator module may include a run button configured to simulate the performance of selected ES Apps. Wherein the profile creator module may be configured to produce an ESS dispatch profile, reports, and analytics that reflect user inputs. Wherein, the produced dispatch profile may be configured to be used as an input to a defined system module. In select embodiments, the profile creator module may be configured to allow the user to specify within the software platform how different ES Apps interact with each other by allowing them to be prioritized, stacked, or interact in another user-defined or pre-set method. The profile creator module may be configured to allow the user to set a user defined timestep and a duration for a simulation and for output results. Wherein based on the user defined timestep and the duration of the simulation, the profile creator module may be configured to produce template interval data CSV files configured to allow the user to input a dataset to be used with selected ES Apps, whereby, using these templates, the user can input load, photovoltaic (PV), wind, thermal plant, hydro-plant or other time-interval profiles and set PCM User Inputs to control how the energy storage dispatch profile will be deduced within the software based on this interval data. Once the user is satisfied with files and data inputted, the profile creator module may be configured to either run in a single run mode configured for if the user wanted to simulate only one case, or a group run mode configured for if the user wanted to run a group of simulations to find the optimal result. Wherein, the user can opt to use a created dispatch profile as the input to the Defined System Module. After running the simulation, the profile creator module may be configured to create reports, graphs, tables, and CSV files that reflect the solution and all associated analytics. Wherein, the profile creator module may also be configured to customize graphs, tables and analytical results that appear in the reports created.

In another aspect, the instant disclosure embraces a method to aid in modeling performance of energy storage systems. The disclosed method to aid in modeling performance of energy storage systems may generally include providing a computer-readable software platform configured to store instructions that, when executed by a computer, cause the software platform to provide an energy storage system defined system module (DSM). The defined system module created by the software platform may be the defined system module in any of the embodiments and/or combination of embodiments shown and/or described herein. Thus, the defined system module may generally be configured to allow a user to deduce performance metrics for a user-defined Energy Storage System (ESS) by executing a user-defined POI Profile deduced by the user or developed through a profile creator module. Wherein, the defined system module may be configured to deduce parameters that allow the user to optimize the design of the energy storage system for a specific ES App.

In select embodiments of the disclosed method or software configured to aid in modeling performance of energy storage systems, the defined system module may include DSM User Inputs, a DSM Simulation component, and a DSM Results Creation component. In select embodiments, the DSM User Inputs may be configured to allow the user to select and specify: a POI Profile, which is either user developed or output from the profile creator module; a Typical Meteorological Year data file in (*.csv) format, which is either user developed or sourced from a third-party; to create new or edit existing equipment models using a component editor; equipment models for a user defined system (UDS); system specifications for the UDS, the system specifications including equipment count, and architecture; a sizing assist continuously updates and shows UDS parameters and compares with those needed by the POI profile; ESS Operational Parameters; ESS Degradation Estimation Assumptions for the UDS; and/or a DSM Run Mode including a single run or a group run. In select embodiments, the DSM Simulation component may be designed and configured to: allow the user to click a Run button; check for errors in the DSM User inputs or incompatibilities in the UDS, wherein, if any errors exist, the DSM Solution Development component is configured to alert the user to fix, and wherein if no errors exist, the DSM Solution Development component is configured to continue; analyzes the DSM User Inputs; deduce all ESS States during execution of the POI Profile with the UDS; and/or deduce a DSM Solution Data Set, and activates the Generate Report and the Generate Output CSVs buttons. In select embodiments, the DSM Results Creation component may be designed and configured to: allow the user to click the Generate Report button; create DSM Report files in PDF format and saves the DSM Report files in the user specified location; open created DSM Report files for the user to visualize; allow the user to click the Generate Output CSVs button; and/or create DSM CSV files in CSV format and saves the DSM CSV files in the user specified location.

One feature of the disclosed method to aid in modeling performance of energy storage systems may be that the parameters deduced by the defined system module may include system energy losses, efficiency, battery degradation estimates, throughput, depth of discharge, C-rate, average State of Charge (SoC), and many other parameters that allow the user to optimize the design of the energy storage system for specific ES Apps. Wherein, the defined system module may include a DSM interface configured to allow the user to input user inputs that describe a user specified energy storage system and how it will be operated. In select embodiments, the user inputs may include a set of parameters and files. Wherein, the defined system module may be configured to allow the user to input the user defined POI Profile that represents how the energy storage system will be dispatched controlled, where the user defined POI Profile may be either developed within the profile creator module or self-deducted by the user. The defined system module may be configured to allow the user to select a TMY file in (*.csv) format. The defined system module may be configured to allow the user to select models of equipment that will be utilized in the energy storage system. In select embodiments, the models of equipment can be selected from a library of default models provided within the defined system module, or the models of equipment can be created by the user using a software component editor. Wherein, the equipment may include, but is not limited to, energy storage mediums, batteries, inverters, converters, transformers, cables, energy storage enclosures, the like, etc. After selecting the models of equipment, the defined system module may be configured to allow the user to define specifications, architecture and topology of the energy storage system. Wherein, as the user defines the specifications, the architecture and the topology, a sizing assist tool may be configured to show the user how the energy storage system specified compares in capacity , energy, voltage, power, and current to the requirements of the user defined POI Profile. In select embodiments, the sizing assist tool may be configured to show the user compatibility of devices specified or lack thereof. Wherein, the defined system module may also be configured to allow the user to specify operational requirements of the contemplated energy storage system and state of health and degradation parameters to be assumed in the simulation. The defined system module may be configured to allow the user to run the simulation to deduce critical information about the performance of the user defined system. In select embodiments, the defined system module may be configured to allow the user to run the simulation in a single run mode configured to simulate only one case, or to allow the user to run the simulation in a group run mode configured to run a group of simulations to find an optimal result. After running the simulation, the defined system module may be configured to allow the user to create reports, graphs, tables and CSV files that reflect the solution. Wherein, the defined system module may be configured to create graphs, tables, and analytical results to appear in the reports created.

The foregoing illustrative summary, as well as other exemplary objectives and/or advantages of the disclosure, and the manner in which the same are accomplished, are further explained within the following detailed description and its accompanying drawings.

### BRIEF DESCRIPTION OF THE DRAWINGS

The present disclosure will be better understood by reading the Detailed Description with reference to the accompanying drawings, which are not necessarily drawn to scale, and in which like reference numerals denote similar structure and refer to like elements throughout, and in which:

FIG. 1 is a schematic showing the main stages of data flow within the PCM module of the software according to select embodiments of the instant disclosure, where the first stage includes “User Inputs” and shows the different types of data, files and parameters that the user specifies, the second stage shows algorithms built within the “Modeling & Computation Engine” of the PCM module of the software, and the third stage shows the types, formats, and variety of results that are outputted to the user following completion of the simulation, on command.

FIG. 2 is a schematic showing the main stages of data flow within the DSM module of the software according to select embodiments of the instant disclosure, where the first stage includes “User Inputs” and shows the different types of data, files and parameters that the user specifies, the second stage shows algorithms built within the “Modeling & Computation Engine” of the DSM module of the software, and the third stage shows the types, formats, and variety of results that are outputted to the user following completion of the simulation, on command;

FIG. 3 shows the flow chart for the PCM (the module within the software focused on creating ESS dispatch profiles) according to select embodiments of the instant disclosure;

FIG. 4 shows the flow chart for the DSM module of the software (the module within the software focused on accurately modeling ESSs) according to select embodiments of the instant disclosure;

FIG. 5 shows a screenshot of the software according to select embodiments of the instant disclosure with the PCM tab opened, where some sample ES Apps or use cases are shown to be selected and the Global User Definitions tab is opened (shown text boxes, inputs, parameters, Apps, buttons, tools in this screenshot are not exhaustive and will be expanded);

FIG. 6 shows a screenshot of the software according to select embodiments of the instant disclosure with the PCM tab opened, where some sample ES Apps or use cases are shown to be selected and the Schedule ES App tab is opened (shown text boxes, inputs, parameters, Apps, buttons, tools in this screenshot are not exhaustive and may be expanded);

FIG. 7 shows a screenshot of the software according to select embodiments of the instant disclosure with the PCM tab opened, where some sample ES Apps or use cases are shown to be selected and the Peak Load Shaving ES App tab is opened. Within the Peak Load Shaving Application Details section, the “General” tab is open (shown text boxes, inputs, parameters, Apps, buttons, tools in this screenshot are not exhaustive and will be expanded);

FIG. 8 Shows a screenshot of the software according to select embodiments of the instant disclosure with the PCM tab opened. Some sample ES Apps or use cases are shown to be selected and the Peak Load Shaving ES App tab is opened. Within the Peak Load Shaving Application Details section, the “Dispatch Parameters” tab is open (shown text boxes, inputs, parameters, Apps, buttons, tools in this screenshot are not exhaustive and may be expanded);

FIG. 9 shows a screenshot of the software according to select embodiments of the instant disclosure with the DSM tab opened, where the “Interval Data” sub-tab is opened, and the “Sizing Assist” tool, selected “System Configuration”, and “Status Log” are shown;

FIG. 10 shows a screenshot of the software according to select embodiments of the instant disclosure with the DSM tab opened, where the “Equipment Models” sub-tab is opened, and the “Sizing Assist” tool, selected “System Configuration”, and “Status Log” are shown (shown text boxes, inputs, parameters, Apps, buttons, tools in this screenshot are not exhaustive and may be expanded);

FIG. 11 shows a screenshot of the software according to select embodiments of the instant disclosure with the DSM tab opened, where the “System Specifications” sub-tab is opened, and the “Sizing Assist” tool, selected “System Configuration”, and “Status Log” are shown (shown text boxes, inputs, parameters, Apps, buttons, tools in this screenshot are not exhaustive and may be expanded);

FIG. 12 shows a screenshot of the software according to select embodiments of the instant disclosure with the DSM tab opened, where the “Operational Limits” sub-tab is opened, and the “Sizing Assist” tool, selected “System Configuration”, and “Status Log” are shown (shown text boxes, inputs, parameters, Apps, buttons, tools in this screenshot are not exhaustive and may be expanded);

FIG. 13 shows a screenshot of the software according to select embodiments of the instant disclosure with the DSM tab opened, where the “Battery Degradation” sub-tab is opened, and the “Sizing Assist” tool, selected “System Configuration”, and “Status Log” are shown (shown text boxes, inputs, parameters, Apps, buttons, tools in this screenshot are not exhaustive and may be expanded);

FIG. 14 shows the Component Editor of the software according to select embodiments of the instant disclosure with a battery model displayed in the novel .btt file format for energy storage technologies, where tabs open in this screenshot are “General” and “Cell” tabs (tabs, parameters, textboxes shown in this screenshot are not exhaustive and may be expanded);

FIG. 15 shows the Component Editor of the software according to select embodiments of the instant disclosure with a battery model displayed in the novel .btt file format for energy storage technologies, where tabs open in this screenshot are “Module” and “Degradation” tabs (tabs, parameters, textboxes shown in this screenshot are not exhaustive and will be expanded); and

FIG. 16 shows the Component Editor of the software according to select embodiments of the instant disclosure with an inverter model displayed in the novel .inv file format for energy storage inverters, where tabs open in this screenshot is the “General” tab (tabs, parameters, textboxes shown in this screenshot are not exhaustive and may be expanded).

It is to be noted that the drawings presented are intended solely for the purpose of illustration and that they are, therefore, neither desired nor intended to limit the disclosure to any or all of the exact details of construction shown, except insofar as they may be deemed essential to the claimed disclosure.

### DETAILED DESCRIPTION

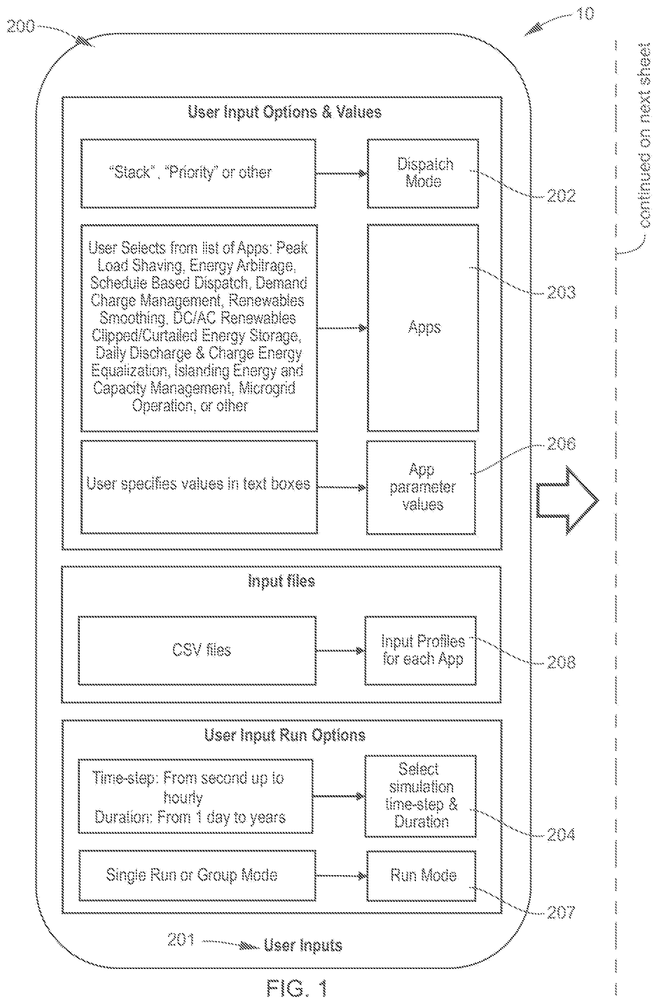

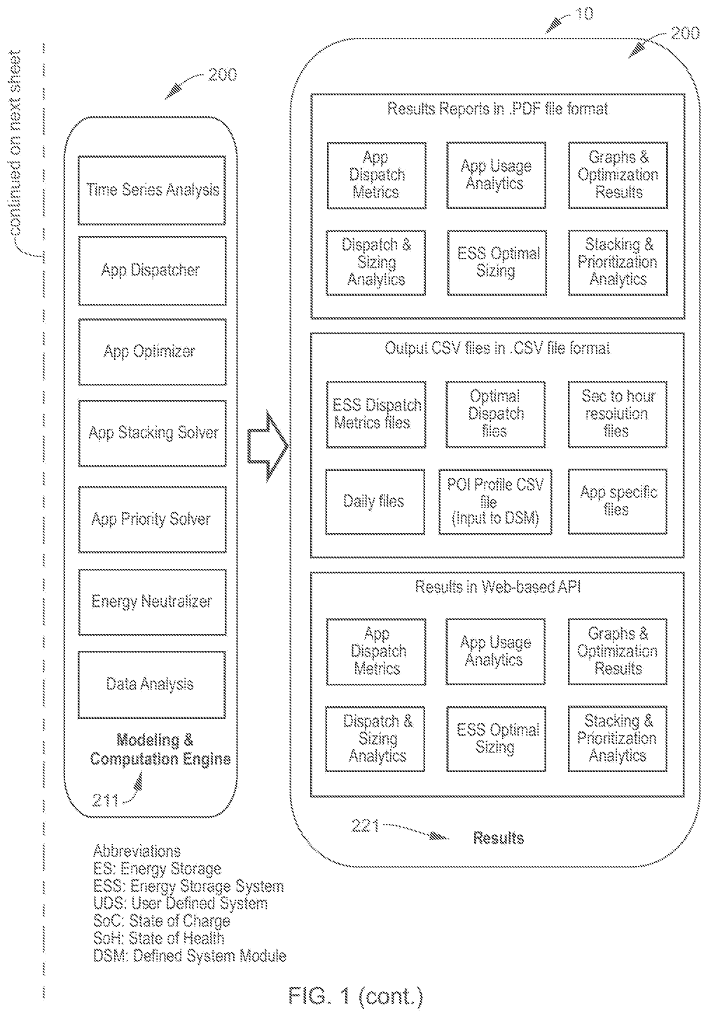

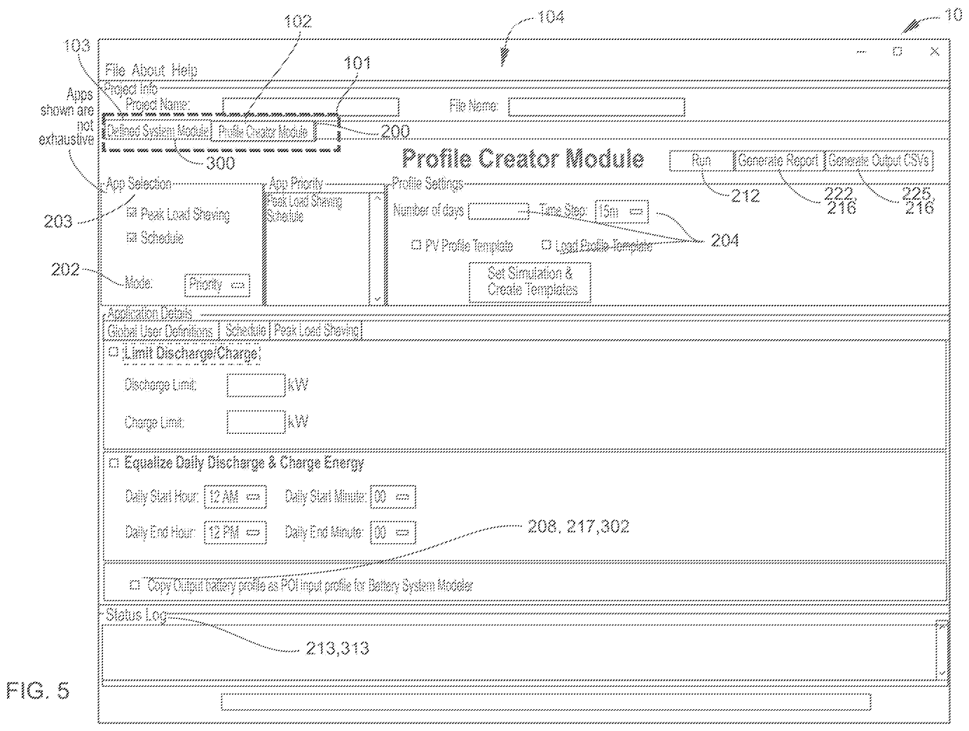

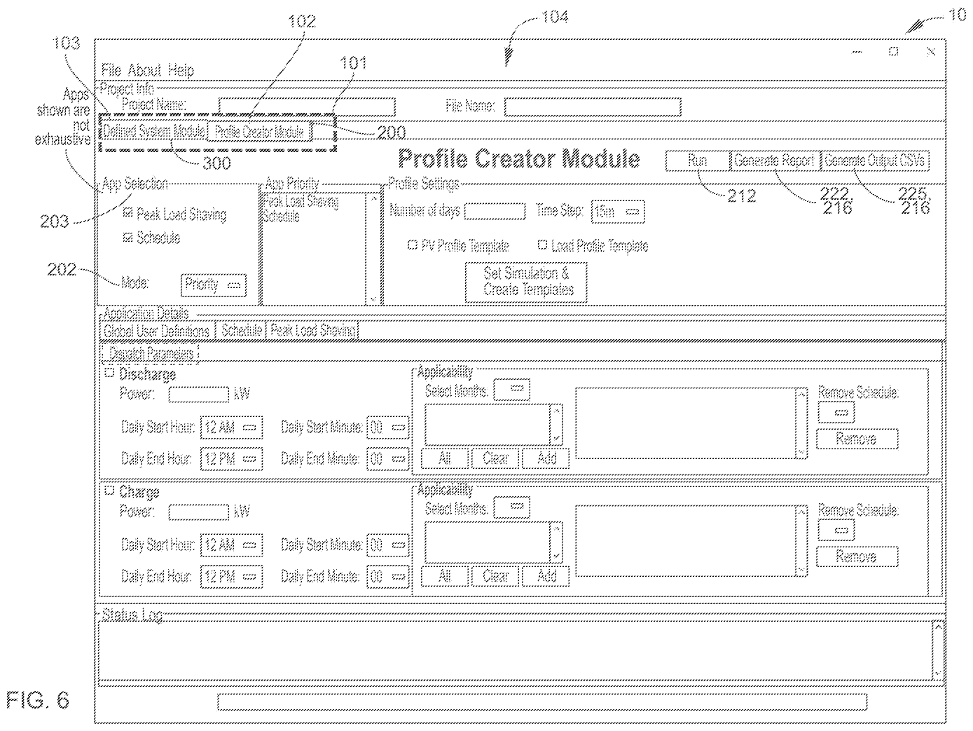

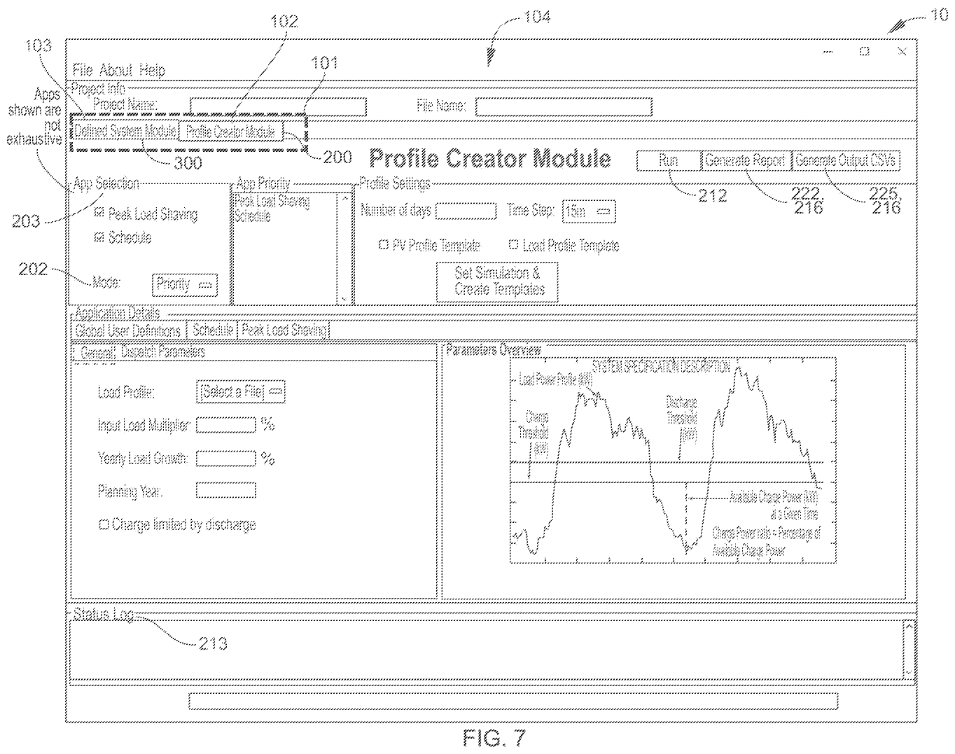

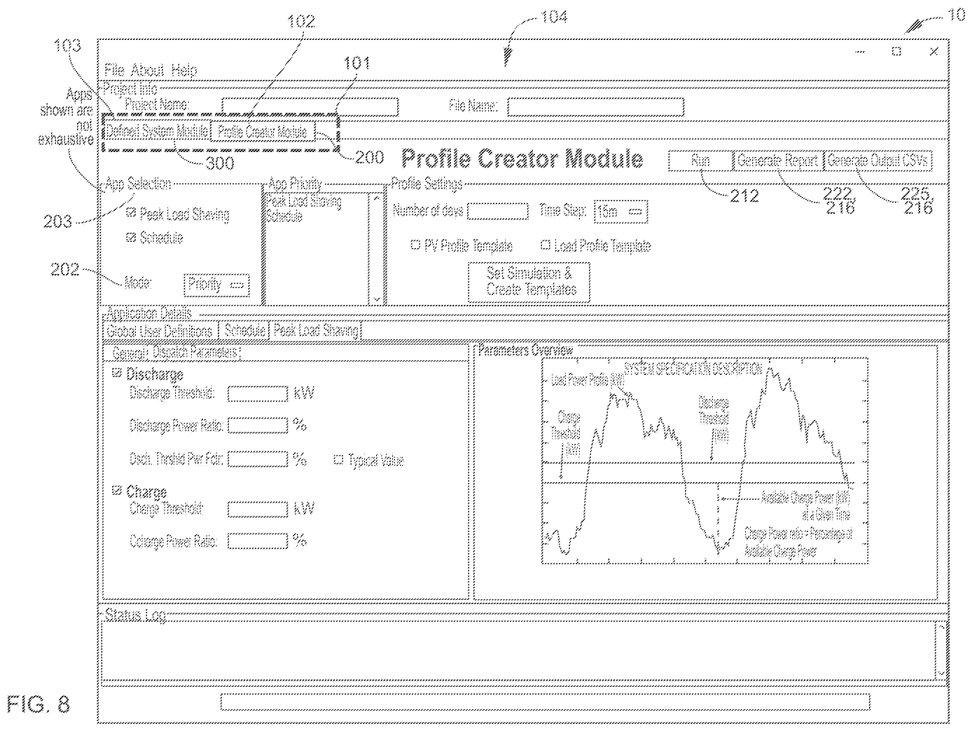

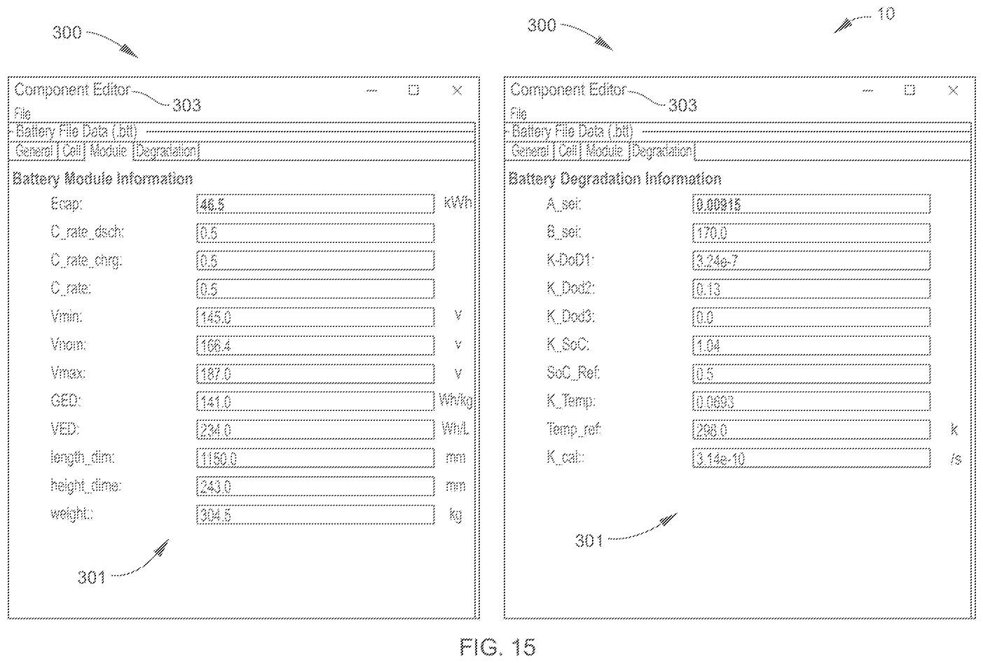

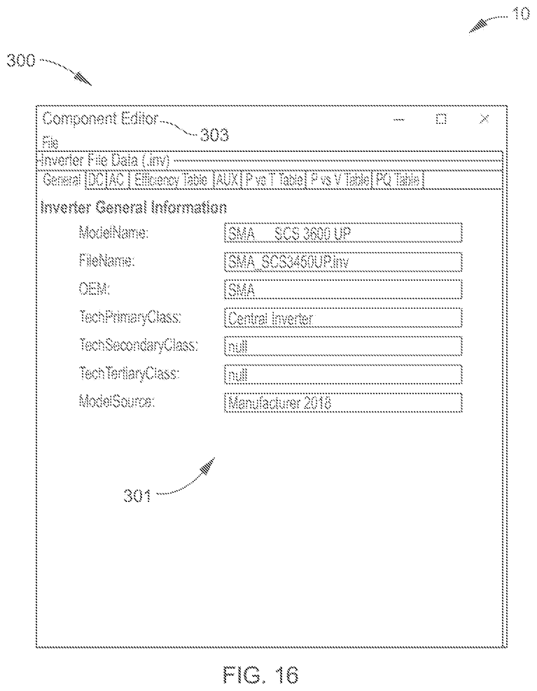

Referring now to FIGS. 1-16, in describing the exemplary embodiments of the present disclosure, specific terminology is employed for the sake of clarity. The present disclosure, however, is not intended to be limited to the specific terminology so selected, and it is to be understood that each specific element includes all technical equivalents that operate in a similar manner to accomplish similar functions. Embodiments of the claims may, however, be embodied in many different forms and should not be construed to be limited to the embodiments set forth herein. The examples set forth herein are non-limiting examples and are merely examples among other possible examples.

As used herein, the following abbreviations may be utilized:
DSM: Defined System Module
ES: Energy Storage
ESS: Energy Storage System
ES Apps: Energy Storage Applications
PCM: Profile Creator Module
POI: Point of Interconnection
SoC: State of Charge
SoH: State of Health
SW: Software
UDS: User Defined System
ESMs: Energy Storage Mediums are devices capable of storing energy like electrochemical batteries, flywheels, gravitational systems, pumped hydro systems, etc.
CSV Files: Comma Separated Values Files
PV: Photovoltaic Technology

Referring to FIGS. 1-16, the present disclosure may solve the aforementioned limitations of the currently available means or mechanisms for creating and modeling energy storage systems, by providing a method or software 10 to aid in creating dispatch profiles of energy storage systems, and/or to model performance of energy storage systems. The disclosed software 10 or software platform 10 may be designed and configured to aid in creating dispatch profiles of energy storage systems, and/or to model performance of energy storage systems and may generally include providing a computer-readable software platform 10 configured to store instructions that, when executed by a computer, cause the software platform to provide an energy storage system profile creator module 200 or PCM 200 and/or an energy storage system defined system module 300 or DSM 300. The energy storage system profile creator module 200 (PCM 200) may be configured to develop energy storage system dispatch profiles for multiple utility, commercial and industrial (C&I), and residential applications use cases (ES Apps). The energy storage system defined system module 300 (DSM 300) may be configured to allow a user to deduce performance metrics for a user-defined Energy Storage System (ESS) by executing a user-defined POI Profile deduced by the user or developed through the profile creator module 200, wherein the defined system module 300 is configured to deduce parameters that allow the user to optimize the design of the energy storage system for a specific ES App.

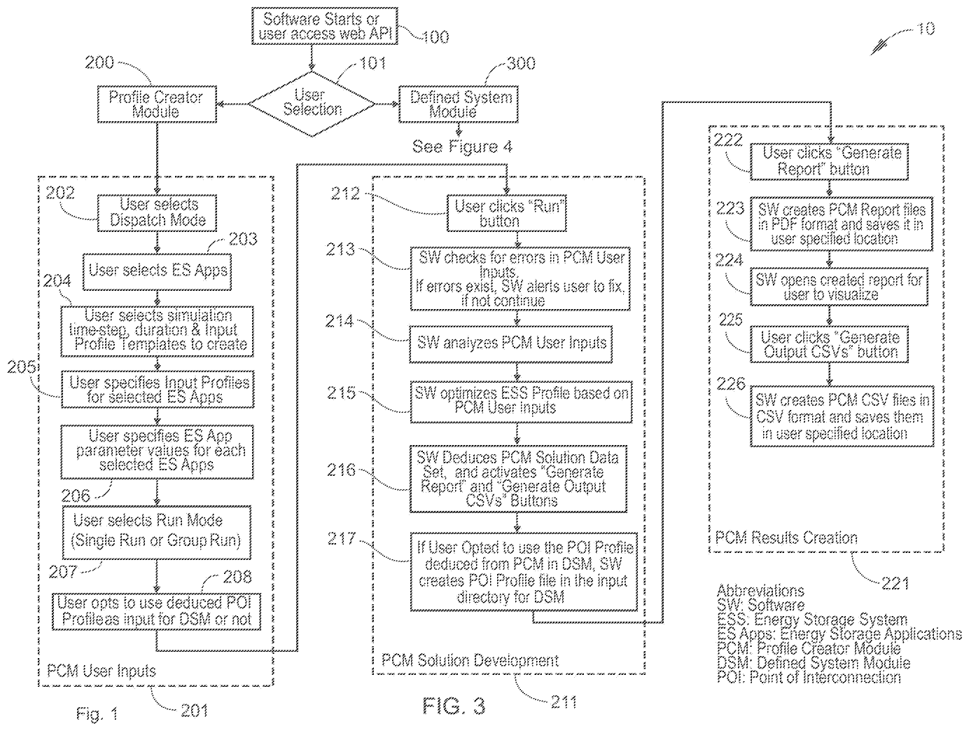

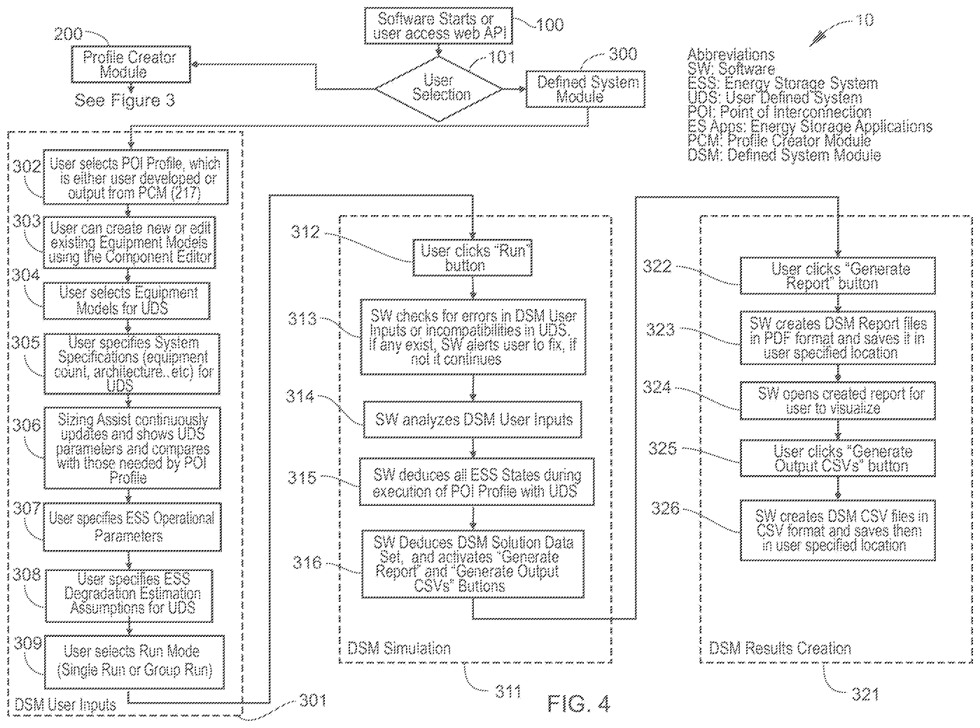

In select embodiments of the disclosed method or software 10 configured to aid in creating dispatch profiles of energy storage systems, and/or to model performance of energy storage systems, the software platform 10 may provide the profile creator module 200, and the defined system module 300. Wherein, when the software platform starts, the user can select 101 either a PCM tab 102 to view and interact with PCM interface 104 of the profile creator module 200, or a DSM tab 103 to view and interact with a DSM interface 105 of the defined system module 300 (see FIGS. 3 and 4).

Referring now specifically to FIGS. 1, 3 and 5-8, the profile creator module 200 is shown for select embodiments of the method or software 10 configured to aid in creating dispatch profiles of energy storage systems, and/or to model performance of energy storage systems. Data flow is shown in FIG. 1 for select embodiments of profile creator module 200 of method or software 10 configured to aid in creating dispatch profiles of energy storage systems, and/or to model performance of energy storage systems. Referring specifically to FIG. 3, PCM data flow is shown for select embodiments of profile creator module 200 of method or software 10 configured to aid in creating dispatch profiles of energy storage systems, and/or to model performance of energy storage systems. Referring specifically to FIGS. 5-8, screenshots are shown for select embodiments of profile creator module 200 of method or software 10 configured to aid in creating dispatch profiles of energy storage systems, and/or to model performance of energy storage systems.

In select embodiments of the disclosed method or software configured to aid in creating dispatch profiles of energy storage systems, and/or to model performance of energy storage systems, the profile creator module 200 may include PCM User inputs 201, a PCM Solution Development component 211, and a PCM Results Creation component. In select embodiments, the PCM User Inputs 201 may be configured to allow the user to select and specify: a Dispatch Mode 202; the ES Apps 203; a Simulation Time-step, duration and input profile templates to create 204; input profiles 205 for selected ES Apps 203; ES App parameter values 206 for each selected ES App 203; a PCM Run Mode 207 of a single run or a group run; and/or an option to use Deduced POI Profiles 208 as input for DSM 300 or not. In select embodiments, the PCM Solution Development component 211 may be designed and configured to: allow the user to click a Run button 212; check for errors 213 in the PCM User Inputs 201, wherein if an error exists, the PCM Solution Development component is configured to alert the user to fix, and wherein if no errors exist, the PCM Solution Development component 211 is configured to continue; analyze 214 the PCM User Inputs 201; optimize 215 an ESS Profile based on the PCM User Inputs 201; deduce 216 a PCM Solution Data Set, and activate a Generate Report button 22, and a Generate Output CSVs button 225; and/or if the user opted to use the POI Profile Deduced from the profile creator module 200 in the defined system module 300, create 217 a POI profile file in an input directory for the defined system module 300. In select embodiments, the PCM Results Creation component 221 may be configured to: allow the user to click a Generate Report button 222; create PCM Report files 223 in PDF format and save the PCM Report files in a user specified location; open 224 the created PCM Report files for user to visualize; allow the user to click Generate Output CSVs button 225; and/or create PCM CSV files 226 in CSV format and save the created PCM CSV files in a user specified location.

In select embodiments of the disclosed method or software 10 configured to aid in creating dispatch profiles of energy storage systems, and/or to model performance of energy storage systems, the energy storage system dispatch profiles developed by the profile creator module 200 may include, but are not limited to, Peak Load Shaving, Energy Arbitrage, Schedule Based Dispatch, Demand Charge Management, Renewables Smoothing, Renewables Firming, DC/AC Renewables Clipped/Curtailed Energy Storage, Daily Discharge & Charge Energy Equalization, Islanding Energy and Capacity Management, and Microgrid Operation.

One feature of the disclosed method or software 10 configured to aid in creating dispatch profiles of energy storage systems, and/or to model performance of energy storage systems may be that the profile creator module 200 may include a PCM interface configured to allow the user to input PCM User Inputs 201 specific to multiple ES Apps 203. In select embodiments, the PCM User Inputs 201 may include, but are not limited to, a set of PCM parameters and CSV files.

In select embodiments of the disclosed method or software 10 configured to aid in creating dispatch profiles of energy storage systems, and/or to model performance of energy storage systems, the profile creator module 200 may include a run button 212 configured to simulate the performance of selected ES Apps 203. In select embodiments, the profile creator module 200 may be configured to produce, but is not limited to, an ESS dispatch profile, reports, and analytics that reflect user inputs. In select embodiments, the produced dispatch profile may be configured to be used as an input to the defined system module 300.

Another feature of the disclosed method or software 10 configured to aid in creating dispatch profiles of energy storage systems, and/or to model performance of energy storage systems may be that the profile creator module 200 may be configured to allow the user to specify within the software platform how different ES Apps 203 interact with each other by allowing them to be prioritized, stacked, or interact in another user-defined or pre-set method. Wherein, in select embodiments, the profile creator module 200 may be configured to allow the user to set a user defined timestep and a duration for a simulation and for output results. Wherein, based on the user defined timestep and the duration of the simulation, in select embodiments, the profile creator module 200 may be configured to produce template interval data CSV files configured to allow the user to input a dataset to be used with selected ES Apps 203. Whereby, using these templates, the user can input load, as examples, and clearly not limited thereto, photovoltaic (PV), wind, thermal plant, hydro-plant or other time-interval profiles and set PCM User Inputs 201 to control how the energy storage dispatch profile will be deduced within software 10 based on this interval data.

Another feature of the disclosed method or software 10 configured to aid in creating dispatch profiles of energy storage systems, and/or to model performance of energy storage systems may be that once the user is satisfied with files and data inputted, the profile creator module 200 may be configured to either run in a single run mode configured for if the user wanted to simulate only one case, or a group run mode configured for if the user wanted to run a group of simulations to find the optimal result. Wherein, in select embodiments, the user can opt to use a created dispatch profile as the input to the defined system module 300.

Another feature of the disclosed method or software 10 configured to aid in creating dispatch profiles of energy storage systems, and/or to model performance of energy storage systems may be that after running the simulation, the profile creator module 200 may be configured to create reports, graphs, tables, and CSV files that may reflect the solution and all associated analytics. Wherein, the profile creator module 200 may also be configured to customize graphs, tables and analytical results that appear in the reports created.

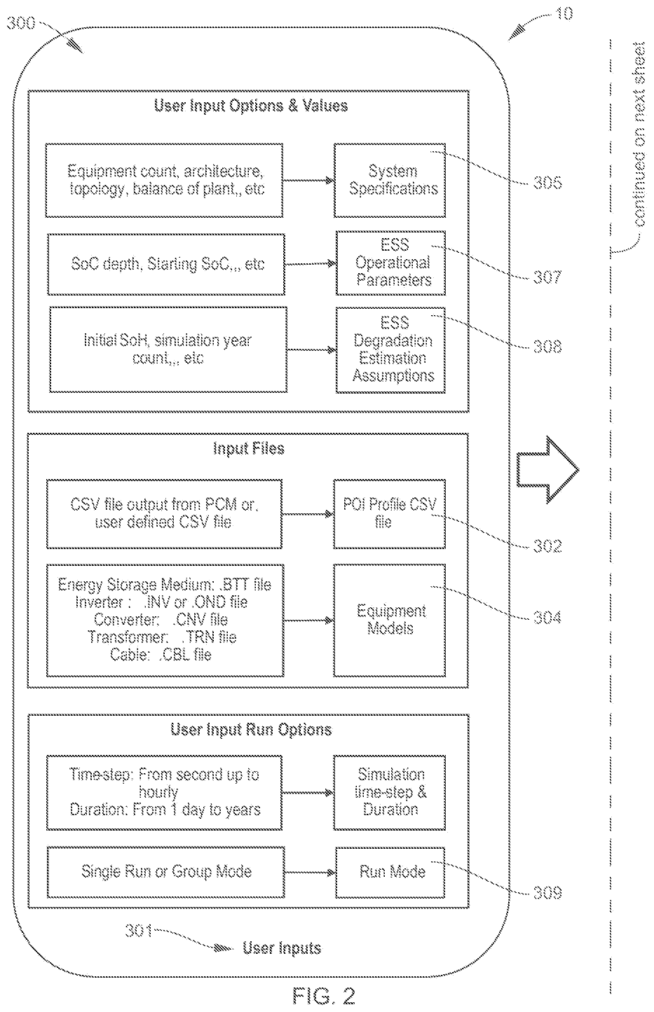

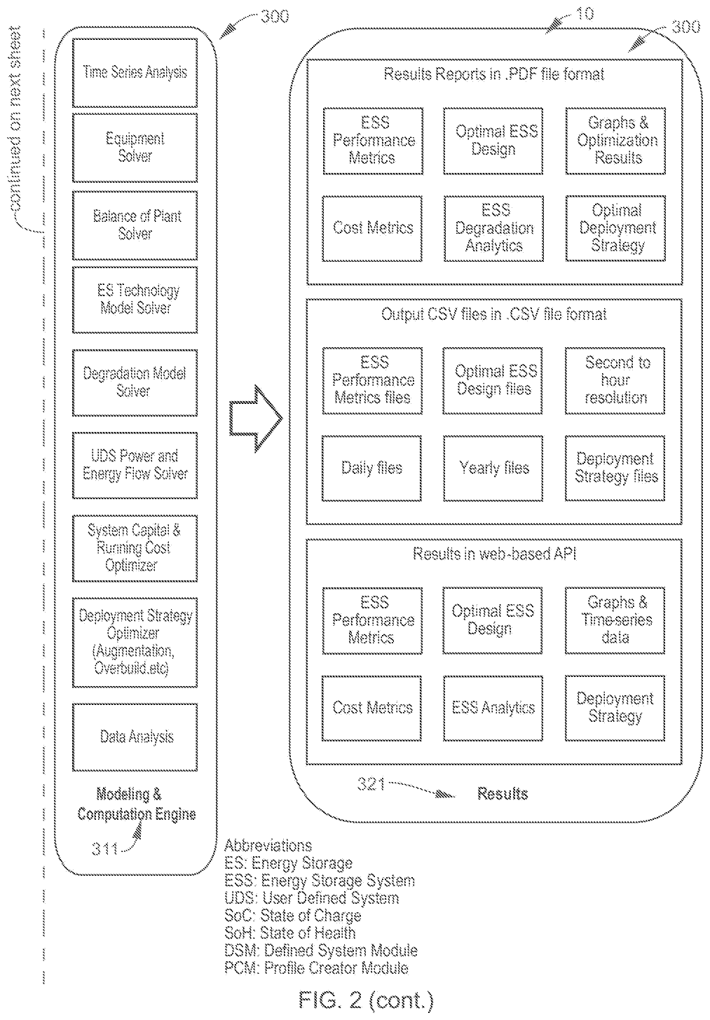

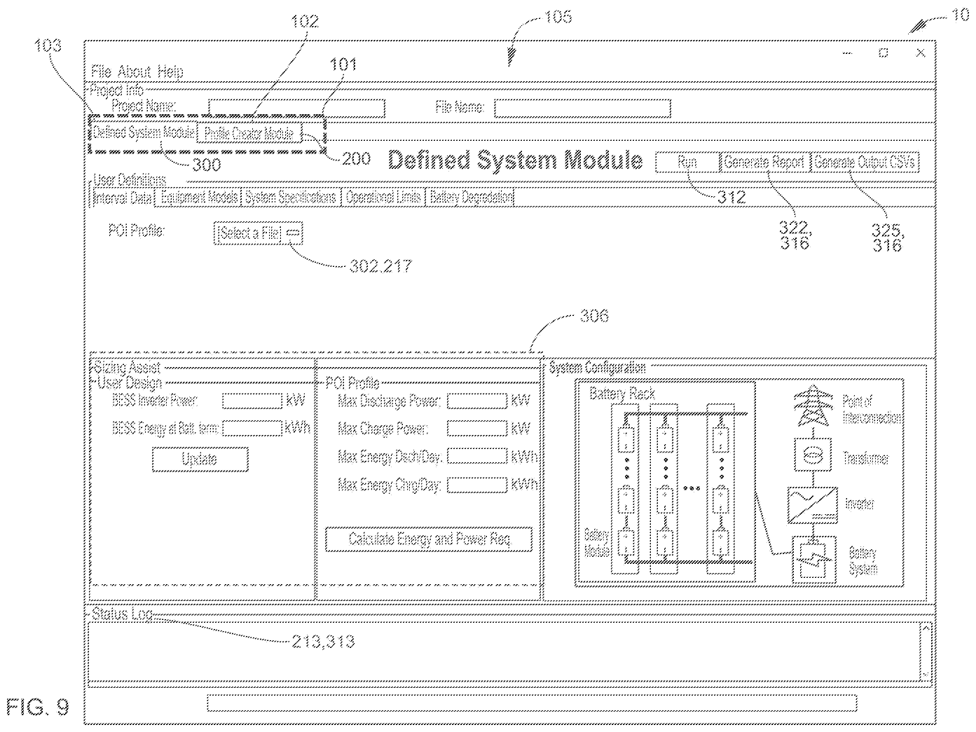

Referring now specifically to FIGS. 2, 4 and 9-16, the defined system module 300 is shown for select embodiments of the method or software 10 configured to aid in creating dispatch profiles of energy storage systems, and/or to model performance of energy storage systems. Data flow is shown in FIG. 2 for select embodiments of defined system module 300 of method or software 10 configured to aid in creating dispatch profiles of energy storage systems, and/or to model performance of energy storage systems. Referring specifically to FIG. 4, DSM data flow is shown for select embodiments defined system module 300 of method or software 10 configured to aid in creating dispatch profiles of energy storage systems, and/or to model performance of energy storage systems. Referring specifically to FIGS. 9-16, screenshots are shown for select embodiments defined system module 300 of method or software 10 configured to aid in creating dispatch profiles of energy storage systems, and/or to model performance of energy storage systems.

In select embodiments of the disclosed method or software 10 configured to aid in creating dispatch profiles of energy storage systems, and/or to model performance of energy storage systems, the defined system module 300 may include DSM User Inputs 301, a DSM Simulation component 311, and a DSM Results Creation component 321. In select embodiments, the DSM User Inputs 301 may be configured to allow the user to select and specify: a POI Profile 302, which is either user developed or output from the profile creator module 200; a Typical Meteorological Year (TMY) data file in (*.csv) format, which is either user developed or sourced from a third-party; to create new or edit existing equipment models using a component editor 303; equipment models 304 for a user defined system (UDS); system specifications 305 for the UDS, the system specifications 305 including, but not limited to, equipment count, and architecture; a sizing assist 306 continuously updates and shows UDS parameters and compares with those needed by the POI profile; ESS Operational Parameters 307; ESS Degradation Estimation Assumptions 308 for the UDS; and/or a DSM Run Mode 309 including a single run or a group run. In select embodiments, the DSM Simulation component 311 may be designed and configured to: allow the user to click a Run button 312; check 313 for errors in the DSM User inputs or incompatibilities in the UDS, wherein, if any errors exist, the DSM Solution Development component 311 is configured to alert the user to fix, and wherein if no errors exist, the DSM Solution Development component 311 is configured to continue; analyze 314 the DSM User Inputs; deduce 315 all ESS States during execution of the POI Profile with the UDS; and/or deduce 316 a DSM Solution Data Set, and activates the Generate Report button 322 and the Generate Output CSVs buttons 325. In select embodiments, the DSM Results Creation component 321 may be designed and configured to: allow the user to click the Generate Report button 322; create DSM Report files 323 in PDF format and saves the DSM Report files in the user specified location; open 324 created DSM Report files for the user to visualize; allow the user to click the Generate Output CSVs button 325; and/or create DSM CSV files 326 in CSV format and saves the DSM CSV files in the user specified location.

In select embodiments of the disclosed method or software 10 configured to aid in creating dispatch profiles of energy storage systems, and/or to model performance of energy storage systems, the parameters deduced by the defined system module 300 may include system energy losses, efficiency, battery degradation estimates, throughput, depth of discharge, C-rate, average State of Charge (SoC), and many other parameters that allow the user to optimize the design of the energy storage system for specific ES Apps 203.

Another feature of the disclosed method or software 10 configured to aid in creating dispatch profiles of energy storage systems, and/or to model performance of energy storage systems may be that the defined system module 300 may include a DSM interface configured to allow the user to input user inputs that describe a user specified energy storage system and how it will be operated. In select embodiments, the user inputs may include, but are not limited to, a set of parameters and files.

Another feature of the disclosed method or software 10 configured to aid in creating dispatch profiles of energy storage systems, and/or to model performance of energy storage systems may be that the defined system module 300 may be configured to allow the user to input the user defined POI Profile that represents how the energy storage system will be dispatched controlled. In select embodiments, the user defined POI Profile may be developed within the profile creator module 200. In other select embodiments, the user defined POI Profile may be self-deducted by the user.

Another feature of the disclosed method or software 10 configured to aid in creating dispatch profiles of energy storage systems, and/or to model performance of energy storage systems may be that the defined system module 300 may be configured to allow the user to input the user defined TMY file that represents the meteorological conditions of the location at which the ESS is planned to be installed. In select embodiments, the user defined TMY file may be developed by the user. In other select embodiments, the TMY file may be sourced from a third party.

Another feature of the disclosed method or software 10 configured to aid in creating dispatch profiles of energy storage systems, and/or to model performance of energy storage systems may be that the defined system module 300 may be configured to allow the user to select models of equipment that will be utilized in the energy storage system. Wherein, in select embodiments, the models of equipment can be selected from a library of default models provided within the defined system module 300. Or, in other select embodiments, the models of equipment can be created by the user using software component editor 303.

In select embodiments of the disclosed method or software 10 configured to aid in creating dispatch profiles of energy storage systems, and/or to model performance of energy storage systems, the models of equipment configured to be selected by the defined system module 300 may include, but are not limited to, energy storage mediums, batteries, inverters, converters, transformers, cables, energy storage enclosures, the like, etc.

Another feature of the disclosed method or software 10 configured to aid in creating dispatch profiles of energy storage systems, and/or to model performance of energy storage systems may be that after selecting the models of equipment, the defined system module 300 may be configured to allow the user to define, as examples, and clearly not limited thereto, specifications, architecture and topology of the energy storage system. Wherein, as the user defines the specifications, the architecture and the topology, in select embodiments a sizing assist tool 306 may be configured to show the user how the energy storage system specified compares in capacity, energy, voltage, power, and current to the requirements of the user defined POI Profile. Wherein, in select embodiments, the sizing assist tool 306 may be configured to show the user compatibility of devices specified or lack thereof. Wherein, in select embodiments, the defined system module 300 may also be configured to allow the user to specify operational requirements of the contemplated energy storage system and state of health and degradation parameters to be assumed in the simulation.

Another feature of the disclosed method or software 10 configured to aid in creating dispatch profiles of energy storage systems, and/or to model performance of energy storage systems may be that the defined system module 300 may be configured to allow the user to run the simulation to deduce critical information about the performance of the user defined system. Wherein, in select embodiments, the defined system module 300 may be configured to allow the user to run the simulation in a single run mode configured to simulate only one case, or to allow the user to run the simulation in a group run mode configured to run a group of simulations to find an optimal result. Wherein, after running the simulation, the defined system module 300 may be configured to allow the user to create, as examples, and clearly not limited thereto, reports, graphs, tables and CSV files that reflect the solution. Wherein, the defined system module 300 may be configured to create graphs, tables, and analytical results to appear in the reports created.

Another feature of the disclosed method or software 10 configured to aid in creating dispatch profiles of energy storage systems, and/or to model performance of energy storage systems may be that the software platform may be configured to introduce a (*.btt) file format for modeling energy storage technologies. The (*.btt) file format may be configured to allow users to accurately compare performance of different energy storage technologies running different applications, thereby allowing the user to select the most appropriate technology for their use-case and optimize designs.

Another feature of the disclosed method or software 10 configured to aid in creating dispatch profiles of energy storage systems, and/or to model performance of energy storage systems may be that the software platform may be configured to introduce a (*.inv) file format for modeling energy storage inverters. The (*.inv) file format may be configured to allow users to accurately compare performance of different inverter products, thereby leading to optimal equipment selection for user designs.

Another feature of the disclosed method or software 10 configured to aid in creating dispatch profiles of energy storage systems, and/or to model performance of energy storage systems may be that the software platform is configured to introduce a (*.cnv) file format for modeling energy storage DC/DC converters. The (*.cnv) file format may be configured to allow users to accurately compare performance of different converter products, thereby leading to optimal equipment selection for user designs.

In select embodiments of the disclosed method or software 10 configured to aid in creating dispatch profiles of energy storage systems, and/or to model performance of energy storage systems, the software platform may be configured to introduce a (*.btt) file format for modeling energy storage technologies, a (*.inv) file format for modeling energy storage inverters, and a (*.cnv) file format for modeling energy storage DC/DC converters. The (*.btt) file format may be configured to allow users to accurately compare performance of different energy storage technologies running different applications, thereby allowing the user to select the most appropriate technology for their use-case and optimize designs. The (*.inv) file format may be configured to allow users to accurately compare performance of different inverter products, thereby leading to optimal equipment selection for user designs. And the (*.cnv) file format may be configured to allow users to accurately compare performance of different converter products, thereby leading to optimal equipment selection for user designs.

Another feature of the disclosed method or software 10 configured to aid in creating dispatch profiles of energy storage systems, and/or to model performance of energy storage systems may be that the software platform 10 may be designed and configured to aid and simplify the process of designing and sizing grid-tied and islanded energy storage systems.

Another feature of the disclosed method or software 10 configured to aid in creating dispatch profiles of energy storage systems, and/or to model performance of energy storage systems may be that the software platform 10 may be designed and configured to allow users to easily deduce energy storage systems dispatch profiles POI profiles and simulate the performance of UDSs by executing the user defined POI profiles.

Another feature of the disclosed method or software 10 configured to aid in creating dispatch profiles of energy storage systems, and/or to model performance of energy storage systems may be that the software platform 10 may be designed and configured to allow accurate estimation of energy storage system performance characteristics including, but not limited to, degradation, round-trip efficiency, losses, and auxiliary load requirements based on user inputted dispatch profiles, or ones developed within the software platform.

Another feature of the disclosed method or software 10 configured to aid in creating dispatch profiles of energy storage systems, and/or to model performance of energy storage systems may be that the software platform may be designed and configured to allow users to create models that accurately reflect the performance of OEM battery products when simulated inside the software platform 10.

Another feature of the disclosed method or software 10 configured to aid in creating dispatch profiles of energy storage systems, and/or to model performance of energy storage systems may be that the software platform 10 may be designed and configured to allow users to create models that accurately reflect the performance of OEM bi-directional inverter products when simulated inside the software platform.

Another feature of the disclosed method or software 10 configured to aid in creating dispatch profiles of energy storage systems, and/or to model performance of energy storage systems may be that the software platform 10 may be designed and configured to allow users to create models that accurately reflect the performance of OEM DC/DC converter products when simulated inside the software platform.

Another feature of the disclosed method or software 10 configured to aid in creating dispatch profiles of energy storage systems, and/or to model performance of energy storage systems may be that the software platform 10 may be designed and configured to allow users to accurately predict how energy storage systems will degrade prior to procurement from ESS OEMs (well after the design phase).

Another feature of the disclosed method or software 10 configured to aid in creating dispatch profiles of energy storage systems, and/or to model performance of energy storage systems may be that the software platform 10 may be designed and configured to allow users to compare between the performance of different Energy Storage (ES) technologies running the users specific application/use-case specific, which allows the user to select the most suitable Energy Storage Medium for their specific use-case. This leads to minimizing project cost and maximizing ESS life.

Another feature of the disclosed method or software 10 configured to aid in creating dispatch profiles of energy storage systems, and/or to model performance of energy storage systems may be that the software platform 10 may be designed and configured to allow users to accurately deduce performance characteristics of Energy Storage (ES) technologies very early in the conception and design phase of grid-tied and islanded ES systems, which results in more accurate estimation of capital and operating cost of conceptualized battery system.

Another feature of the disclosed method or software 10 configured to aid in creating dispatch profiles of energy storage systems, and/or to model performance of energy storage systems may be that the software platform 10 may be designed and configured to provide a standard model file format for Energy Storage Mediums (like batteries, flywheels, compressed air, flow batteries, metal air, etc.) that enables users to compare utilization of different ESMs for their projects.

Another feature of the disclosed method or software 10 configured to aid in creating dispatch profiles of energy storage systems, and/or to model performance of energy storage systems may be that the software platform 10 may be designed and configured to allow users to easily deduce ESS dispatch profiles for different grid-tied and islanded systems' use-cases/applications, thereby preventing the user from needing to write lengthy code or spend hours writing excel formulas.

Another feature of the disclosed method or software 10 configured to aid in creating dispatch profiles of energy storage systems, and/or to model performance of energy storage systems may be that the software platform 10 may be designed and configured to allow users to produce ESS dispatch profiles with multiple use-cases/applications stacked or prioritized based on user requirements, thereby enabling the user to use one ESS for more than one function leading to optimizing performance and maximizing financial revenue of designed energy storage projects.

Another feature of the disclosed method or software 10 configured to aid in creating dispatch profiles of energy storage systems, and/or to model performance of energy storage systems may be that the software platform 10 may be designed and configured to allow users to model ESSs, simulate their performance and create dispatch profiles at variable interval data time-steps, thereby allowing the user to interval data with different time-steps, allowing much needed flexibility in the energy storage system design process, allowing interval data time-step to be as short as one (1) second.

Another feature of the disclosed method or software 10 configured to aid in creating dispatch profiles of energy storage systems, and/or to model performance of energy storage systems may be that the software platform 10 may be designed and configured to allow users to model energy storage systems, simulate their performance and create dispatch profiles at extremely high fidelity, thereby allowing time-steps to be as short as one (1) second, wherein the method 10 may be configured to allow the produced results to be of the highest accuracy reflecting real energy storage system performance.

Another feature of the disclosed method or software 10 configured to aid in creating dispatch profiles of energy storage systems, and/or to model performance of energy storage systems may be that the software platform 10 may be designed and configured to accurately estimate lithium and non-lithium battery technologies degradation throughout project life, considering impacts of Depth of Discharge, C-rate, Average State of Charge, Center State of Charge, Calendar Life, Ambient temperature, amongst other factors separately. This may allow users to optimize use-cases and performance.

Another feature of the disclosed method or software 10 configured to aid in creating dispatch profiles of energy storage systems, and/or to model performance of energy storage systems may be that the software platform 10 may be designed and configured to accurately model energy storage projects' energy losses and round-trip efficiency during operation, considering ambient temperature, C-rate, battery cell specifications, type of cooling systems, project region, dispatch profile and other factors.

Another feature of the disclosed method or software 10 configured to aid in creating dispatch profiles of energy storage systems, and/or to model performance of energy storage systems may be that the software platform 10 may be designed and configured to allow the user full flexibility in the energy storage design process by simplifying development of energy storage systems dispatch profiles and allowing the user to use these profiles directly to model the performance of the actual system.

In another aspect, the instant disclosure embraces a version of method or software 10 configured to aid in creating dispatch profiles for energy storage systems. The disclosed method or software 10 to aid in creating dispatch profiles for energy storage systems may generally include providing computer-readable software platform 10 configured to store instructions that, when executed by a computer, cause the software platform 10 to provide an energy storage system profile creator module 200 (PCM 200). The profile creator module 200 created by the software platform 10 may be the profile creator module 200 in any of the embodiments and/or combination of embodiments shown and/or described herein. Thus, the profile creator module 200 of this embodiment of method or software 10 may generally be configured to develop energy storage system dispatch profiles for multiple utility, commercial and industrial (C&I), and residential applications use cases (ES Apps 203).

In another aspect, the instant disclosure embraces a version of method or software 10 configured to aid in modeling performance of energy storage systems. The disclosed method or software 10 configured to aid in modeling performance of energy storage systems may generally include providing a computer-readable software platform 10 configured to store instructions that, when executed by a computer, cause the software platform 10 to provide an energy storage system defined system module 300 (DSM 300). The defined system module 300 created by the software platform 10 may be the defined system module 300 in any of the embodiments and/or combination of embodiments shown and/or described herein. Thus, the defined system module 300 of this embodiment of method or software 10 may generally be configured to allow a user to deduce performance metrics for a user-defined Energy Storage System (ESS) by executing a user-defined POI Profile deduced by the user or developed through a profile creator module 200. Wherein, the defined system module 300 may be configured to deduce parameters that allow the user to optimize the design of the energy storage system for a specific ES App.

In sum, the disclosed software 10 may include two main modules. The first is called ESS Profile creator module 200 (PCM 200), and the second is called ESS Defined system module 300 (DSM 300). When software 10 starts, the user can select either of PCM tab 102 or DSM tab 103 to view and interact with their respective interfaces 104 and 105. See FIG. 1 for PCM Data Flow and FIG. 2 for DSM Data Flow; also see FIGS. 3&4, reference numbers 100, 101, 200 & 300; also see FIGS. 5 to 16 showing PCM and DSM interfaces). Below are detailed descriptions of example embodiments of PCM 200 and DSM 300.

### EXAMPLES

Referring to FIGS. 1, 3 and 5-8, an example embodiment of energy Storage System Profile creator module 200 (PCM 200) is shown. The purpose of PCM 200 may be to simplify the process of developing energy storage system dispatch profiles for multiple utility, commercial and industrial (C&I), and residential applications (ES Apps 203)/use-cases including but not limited to, Peak Load Shaving, Energy Arbitrage, Schedule Based Dispatch, Demand Charge Management, Renewables Smoothing, Renewables Firming, DC/AC Renewables Clipped/Curtailed Energy Storage, Daily Discharge & Charge Energy Equalization, Islanding Energy and Capacity Management, Microgrid Operation, and others.

PCM 200 may provide the user with an intuitive PCM interface 104 (See FIG. 5) that allows him/her to input a set of parameters, CSV files and other inputs (See FIG. 1 “PCM User Inputs”; Also see FIG. 3, and FIG. 5, reference number 206) specific to multiple energy storage system applications (ES Apps 203)/use-cases (See “Apps” box in “User Input Options & Values” box in “User Inputs” in FIG. 1) and click “run” (See FIG. 3, and FIG. 5, reference number 212) to simulate the performance of the selected ES App(s) and produce an ESS dispatch profile, reports and analytics (See “Results” in FIG. 1) that reflect user inputs.

The produced dispatch profile (See “POI Profile CSV” in FIG. 1) can be used as an input to the other module of software 10 (See “POI Profile CSV File” box in “Input Files” box in “User Inputs” in FIG. 1—Also see reference number 302 in FIGS. 4 and 9), namely Defined system module 300 (DSM 300).

The user can also specify within PCM 200 of software 10 how different applications/use-cases (See FIGS. 3&5, reference number 203 showing selections of some Apps (not exhaustive)) interact with each other by allowing them to be prioritized, stacked, or interact in another user-defined or pre-set method (See “Mode” FIG. 3, and FIG. 5, reference number 202). The user may be allowed to set any timestep and duration for the simulation (See “Profile Settings” in FIG. 3, and FIG. 5, reference number 204) and accordingly, for the output results. Based on user defined timestep and duration of the simulation, software 10 can produce template interval data CSV files (See FIG. 3, and FIG. 5, reference number 204) to allow the user to input his/her own dataset to be used with selected ES Apps 203 (See FIG. 5, reference number 203). Using these templates, the user can input load, photovoltaic (PV), wind, thermal plant, hydro-plant or other time-interval profiles and set PCM User Inputs 201 (See FIG. 3, reference number 201) to control how the energy storage dispatch profile will be deduced within the software (See “Modeling & Computation Engine” in FIG. 1; also see FIG. 3, reference number 211) based on this interval data.

Once the user is satisfied with files and data inputted, the software can be ran either in “Single Run” mode, if user wanted to simulate only one case, or “Group Run” mode, if user wanted to run a group of simulations to find the optimal result (See “Run Mode 207” in “User Input Run Options” box in FIG. 1; also see FIG. 3, reference number 207). The user can opt to use the created dispatch profile as the input to DSM 300 (See FIGS. 3 and 5, reference numbers 208 and 217).

After running the simulation, the user can create reports, graphs, tables, and CSV files that reflect the solution and all associated analytics (See “Results” box in FIG. 1; also see FIGS. 3 and 5, reference numbers 216, 221, 222, 223, 224, 225 & 226). The user can also customize graphs, tables and analytical results that appear in the report.

Referring now to FIGS. 2, 4 and 9-16, an example embodiment of energy Storage System Defined system module 300 (DSM 300) is shown. The purpose of DSM 300 of software may be to allow users to accurately and easily deduce critical performance metrics for a user-defined Energy Storage System (ESS) by executing a user-defined POI Profile (deduced by the user or developed through PCM 200). Using this module, the user can accurately deduce system energy losses, efficiency, battery degradation estimates, throughput, depth of discharge, C-rate, average SoC, and many other parameters that allow the user to optimize the design of the energy storage system for his/her specific ES App/use-case.

DSM 300 may provide the user with an intuitive DSM interface 105 (See FIGS. 9 to 16) that allows him/her to input a set of parameters and files (See “User Inputs” box in FIG. 2; also see FIG. 4, reference number 301; also see FIGS. 9 to 16) that describe a user specified energy storage system and how it will be operated (See some data (not exhaustive) user can input in FIGS. 9 to 16).

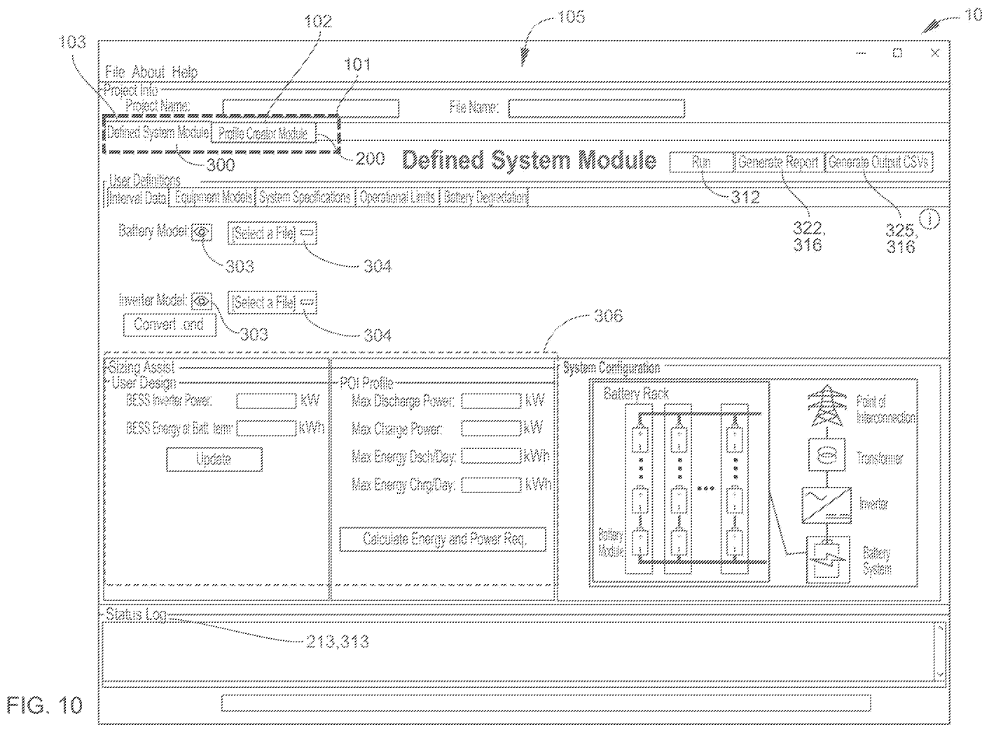

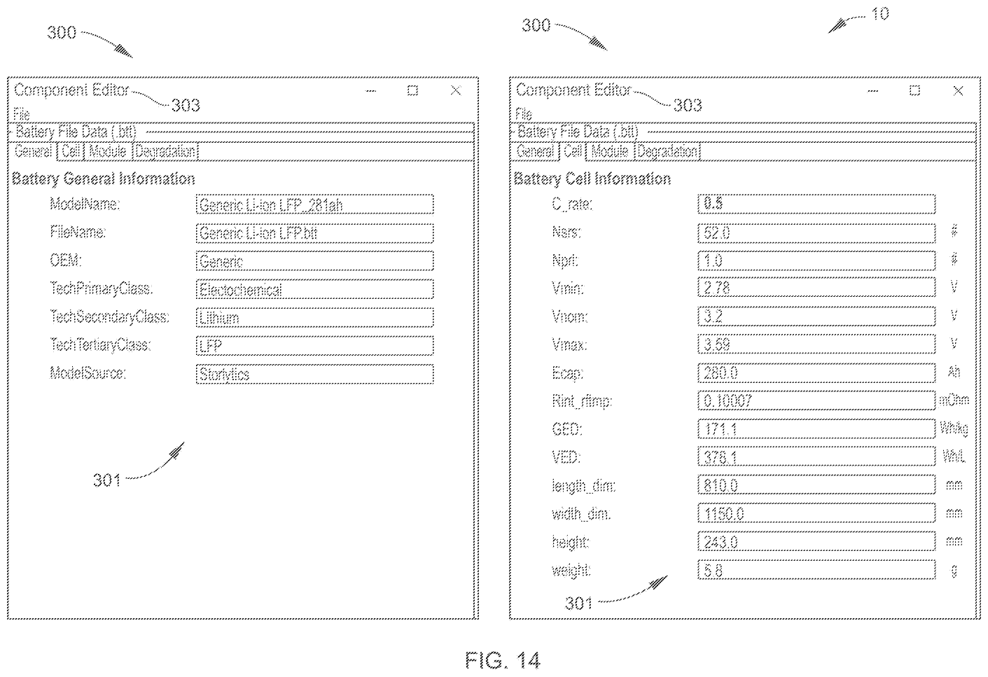

DSM 300 of the disclosed software 10 may also allow the user to input a POI Profile (See FIGS. 4 and 9, reference number 302) that represents how this ESS will be dispatched/controlled. This POI Profile can either be developed within PCM 200 or self-deduced by the user through other means (See FIGS. 4 and 9, reference number 302). The user can also select models for energy storage mediums, batteries, inverters, converters, transformers, cables, energy storage enclosures and other balance of plant equipment that will be utilized in the ESS (See FIGS. 4 and 10, reference numbers 303 and 304). In addition to selecting from a library of default models provided within software 10, the user can also create his/her own equipment models using the software component editor 303 (See FIGS. 14, 15 &16 [not exhaustive]).

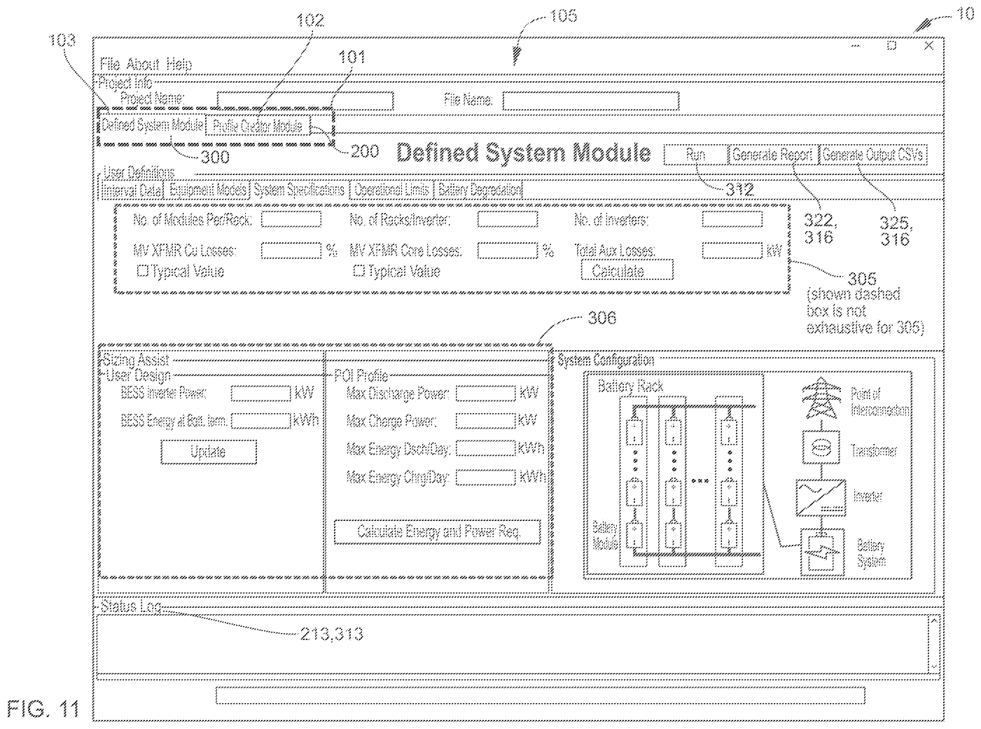

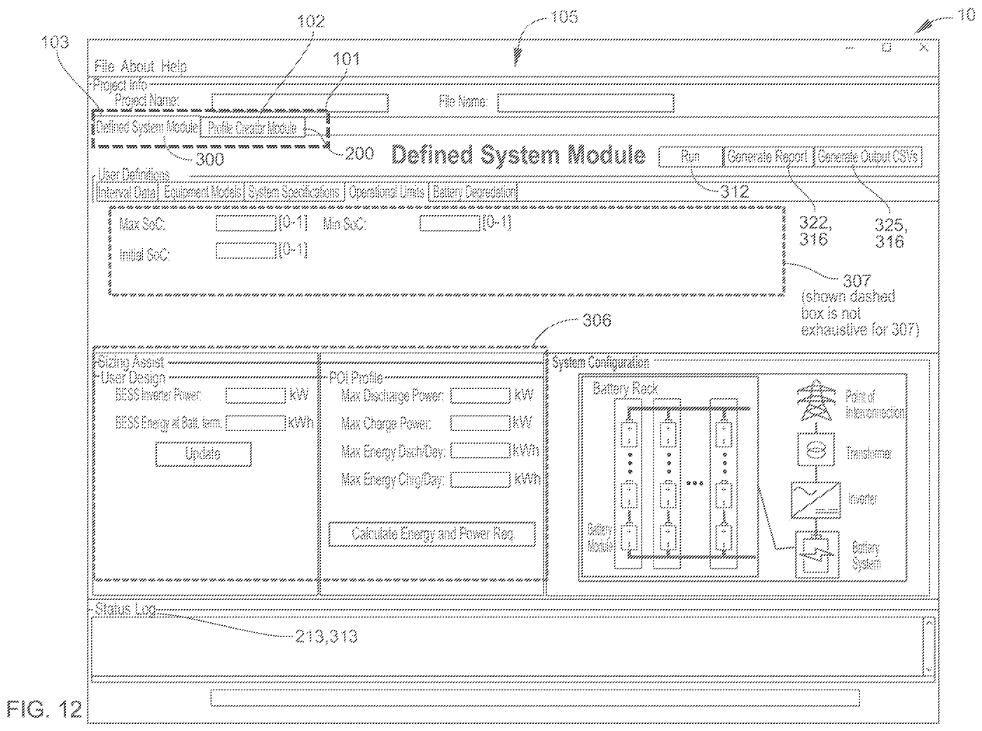

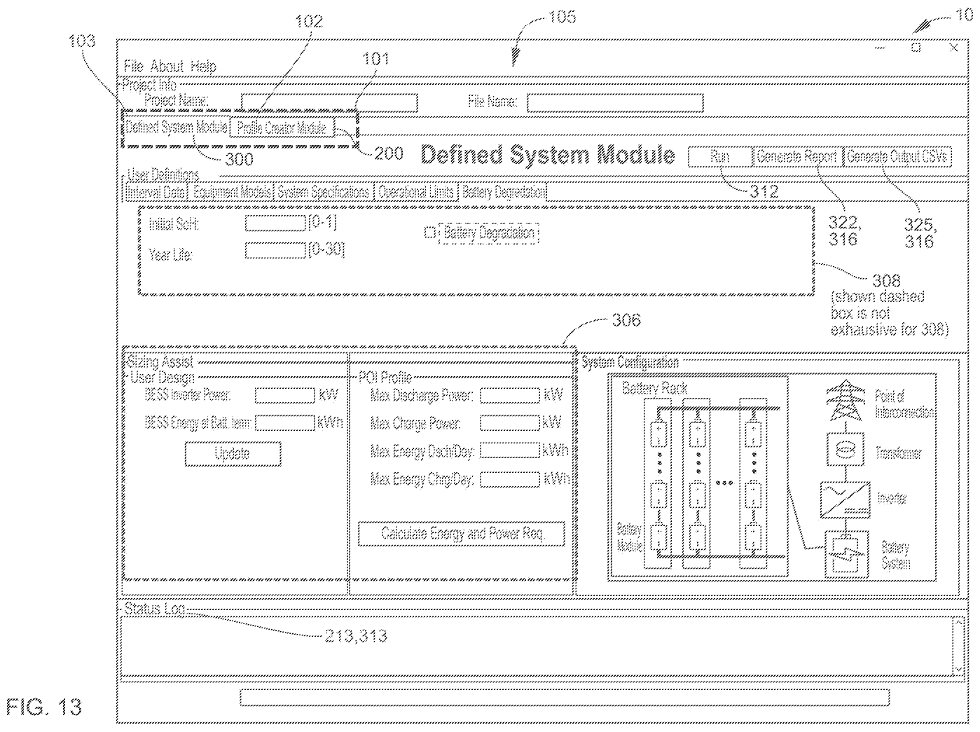

After selecting ESS equipment models, the user can define the ESS specifications, architecture and topology (See FIGS. 4 and 11, reference number 305). As the user is filling out system specifications, the “Sizing Assist” tool 306 may show the user how the system he/she specified compares in capacity, energy, voltage, power, current to the requirements of the “POI Profile” (See FIGS. 4 and 9, reference number 306). The “Sizing Assist” tool 306 may also show the user compatibility of devices specified or lack thereof. The user can also specify operational requirements of the contemplated ESS (See FIGS. 4 and 12, reference number 307) and State of Health and degradation parameters to be assumed in the simulation (See FIGS. 4 and 13, reference number 308).

The user can then run the simulation (See “Modeling & Computation Engine” in FIG. 2; also see FIG. 4, reference number 311; also see FIG. 9, reference number 312) to deduce critical information about the performance of the User Defined System (UDS). The user can also run the simulation in “Single Run” mode, if the user wanted to simulate only one case, or “Group Run” mode, if the user wanted to run a group of simulations to find the optimal result (See “Run Mode” in “User Input Run Options” box in FIG. 2; also see FIG. 4, reference number 309). After running the simulation, the user can create reports, graphs, tables, and CSV files that reflect the solution (See “Results” box in FIG. 2; also see FIGS. 4 and 9, reference numbers 316, 321, 322, 323, 324, 325 & 326). The user can select graphs, tables and analytical results that appear in the report.

***

In the specification and/or figures, typical embodiments of the disclosure have been disclosed. The present disclosure is not limited to such exemplary embodiments. The use of the term “and/or” includes any and all combinations of one or more of the associated listed items. The figures are schematic representations and so are not necessarily drawn to scale. Unless otherwise noted, specific terms have been used in a generic and descriptive sense and not for purposes of limitation.

The foregoing description and drawings comprise illustrative embodiments. Having thus described exemplary embodiments, it should be noted by those skilled in the art that the within disclosures are exemplary only, and that various other alternatives, adaptations, and modifications may be made within the scope of the present disclosure. Merely listing or numbering the steps of a method in a certain order does not constitute any limitation on the order of the steps of that method. Many modifications and other embodiments will come to mind to one skilled in the art to which this disclosure pertains having the benefit of the teachings presented in the foregoing descriptions and the associated drawings. Although specific terms may be employed herein, they are used in a generic and descriptive sense only and not for purposes of limitation. Accordingly, the present disclosure is not limited to the specific embodiments illustrated herein but is limited only by the following claims.

1. A method to aid in creating dispatch profiles for energy storage systems and/or to model performance of energy storage systems comprising:
providing a computer-readable software platform configured to store instructions that, when executed by a computer, cause the software platform to create:
a profile creator module (PCM) for the energy storage systems, the profile creator module is configured to develop energy storage system dispatch profiles for multiple utility, commercial and industrial (C&I), and residential applications use cases (ES Apps); or
a defined system module (DSM) for the energy storage systems, the defined system module is configured to allow a user to deduce performance metrics for a user-defined Energy Storage System (ESS) by executing a user-defined POI Profile deduced by the user or developed through the profile creator module, wherein the defined system module is configured to deduce parameters that allow the user to optimize the design of the energy storage system for a specific ES App.

2. The method of claim 1 wherein the software platform provides:
the profile creator module and the defined system module;
wherein, when the software platform starts, the user can select either a PCM tab to view and interact with a PCM interface of the profile creator module, or a DSM tab to view and interact with a DSM interface of the defined system module;
wherein, the profile creator module including:
PCM User inputs;
a PCM Solution Development component;
a PCM Results Creation component;
wherein, the defined system module including:
DSM User Inputs;
a DSM Simulation component; and
a DSM Results Creation component.

3. The method of claim 2, wherein:
the PCM User inputs are configured to allow the user to select and specify:
a Dispatch Mode;
the ES Apps;
a Simulation Time-step, duration and input profile templates to create;
input profiles for selected ES Apps;
ES App parameter values for each selected ES App;
a PCM Run Mode of a single run or a group run;
an option to use Deduced POI Profiles as input for DSM or not;
the PCM Solution Development component is designed and configured to:
allow the user to click a Run button;
check for errors in the PCM User Inputs, wherein if an error exists, the PCM Solution Development component is configured to alert the user to fix, and wherein if no errors exist, the PCM Solution Development component is configured to continue;
analyze the PCM user inputs;
optimize an ESS Profile based on the PCM User Inputs;
deduce a PCM Solution Data Set, and activate a Generate Report button, and a Generate Output CSVs button;
if the user opted to use the POI Profile Deduced from the profile creator module in the defined system module, create a POI profile file in an input directory for the defined system module;
the PCM Results Creation component is configured to:
allow the user to click a Generate Report button;
create PCM Report files in PDF format and save the PCM Report files in a user specified location;
open the created PCM Report files for user to visualize;
allow the user to click Generate Output CSVs button;
create PCM CSV files in CSV format and save the created PCM CSV files in a user specified location;
the DSM User Inputs are configured to allow the user to select and specify:
a POI Profile, which is either user developed or output from the profile creator module;
a Typical Meteorological Year (TMY) data file in (*.csv) format, which is either user developed or sourced from a third-party;
to create new or edit existing equipment models using a component editor;
equipment models for a user defined system (UDS);
system specifications for the UDS, the system specifications including equipment count, and architecture;
a sizing assist continuously updates and shows UDS parameters and compares with those needed by the POI profile;
ESS Operational Parameters;
ESS Degradation Estimation Assumptions for the UDS
a DSM Run Mode including a single run or a group run;
the DSM Simulation component is designed and configured to:
allow the user to click a Run button;
check for errors in the DSM User inputs or incompatibilities in the UDS, wherein, if any errors exist, the DSM Solution Development component is configured to alert the user to fix, and wherein if no errors exist, the DSM Solution Development component is configured to continue;
analyzes the DSM User Inputs;
deduces all ESS States during execution of the POI Profile with the UDS;
deduces a DSM Solution Data Set, and activates the Generate Report and the Generate Output CSVs buttons;
the DSM Results Creation component is designed and configured to:
allow the user to click the Generate Report button;
create DSM Report files in PDF format and saves the DSM Report files in the user specified location;
open created DSM Report files for the user to visualize;
allow the user to click the Generate Output CSVs button; and
create DSM CSV files in CSV format and saves the DSM CSV files in the user specified location.

4. The method of claim 3, wherein:
the energy storage system dispatch profiles developed by the profile creator module including Peak Load Shaving, Energy Arbitrage, Schedule Based Dispatch, Demand Charge Management, Renewables Smoothing, Renewables Firming, DC/AC Renewables Clipped/Curtailed Energy Storage, Daily Discharge & Charge Energy Equalization, Islanding Energy and Capacity Management, and Microgrid Operation; and
the parameters deduced by the defined system module including system energy losses, efficiency, battery degradation estimates, throughput, depth of discharge, C-rate, average State of Charge (SoC), and many other parameters that allow the user to optimize the design of the energy storage system for specific ES Apps.

5. The method of claim 4, wherein:
the profile creator module including a PCM interface configured to allow the user to input the PCM user inputs specific to multiple ES Apps, wherein the PCM user inputs including a set of PCM parameters and CSV files;
the profile creator module including a run button configured to simulate the performance of selected ES Apps, wherein the profile creator module is configured to produce an ESS dispatch profile, reports, and analytics that reflect user inputs, the produced dispatch profile is configured to be used as an input to the defined system module;
the profile creator module is configured to allow the user to specify within the software platform how different ES Apps interact with each other by allowing them to be prioritized, stacked, or interact in another user-defined or pre-set method, wherein the profile creator module is configured to allow the user to set a user defined timestep and a duration for a simulation and for output results, wherein based on the user defined timestep and the duration of the simulation, the profile creator module is configured to produce template interval data CSV files configured to allow the user to input a dataset to be used with selected ES Apps, whereby, using these templates, the user can input load, photovoltaic (PV), wind, thermal plant, hydro-plant or other time-interval profiles and set PCM User Inputs to control how the energy storage dispatch profile will be deduced within the software based on this interval data;
the defined system module includes a DSM interface configured to allow the user to input the DSM user inputs that describe a user specified energy storage system and how it will be operated, wherein the DSM user inputs including a set of parameters and files;
the defined system module is configured to allow the user to input the user defined POI Profile that represents how the energy storage system will be dispatched controlled, where the user defined POI Profile is either developed within the profile creator module or self-deducted by the user;
the defined system module is configured to allow the user to input the user defined TMY file that represents the meteorological conditions of the location at which the ESS is planned to be installed, where the user defined TMY file is either developed by the user or is sourced from a third party;
the defined system module is configured to allow the user to select models of equipment that will be utilized in the energy storage system, wherein the models of equipment can be selected from a library of default models provided within the defined system module, or the models of equipment can be created by the user using a software component editor; and
the models of equipment configured to be selected by the defined system module including energy storage mediums, batteries, inverters, converters, transformers, energy storage enclosures, and cables.

6. The method of claim 5, wherein:
once the user is satisfied with files and data inputted, the profile creator module is configured to either run in a single run mode configured for if the user wanted to simulate only one case, or a group run mode configured for if the user wanted to run a group of simulations to find the optimal result, wherein the user can opt to use a created dispatch profile as the input to the defined system module; and
after selecting the models of equipment, the defined system module is configured to allow the user to define specifications, architecture and topology of the energy storage system, and wherein, as the user defines the specifications, the architecture and the topology, a sizing assist tool is configured to show the user how the energy storage system specified compares in capacity, energy, voltage, power, and current to the requirements of the user defined POI Profile, wherein the sizing assist tool is configured to show the user compatibility of devices specified or lack thereof, and wherein, the defined system module is also configured to allow the user to specify operational requirements of the contemplated energy storage system and state of health and degradation parameters to be assumed in the simulation.

7. The method of claim 6, wherein:
after running the simulation, the profile creator module is configured to create reports, graphs, tables, and CSV files that reflect the solution and all associated analytics, wherein the profile creator module is also configured to customize graphs, tables and analytical results that appear in the reports created; and
the defined system module is configured to allow the user to run the simulation to deduce critical information about the performance of the user defined system, wherein the defined system module is configured to allow the user to run the simulation in a single run mode configured to simulate only one case, or to allow the user to run the simulation in a group run mode configured to run a group of simulations to find an optimal result, wherein, after running the simulation, the defined system module is configured to allow the user to create reports, graphs, tables and CSV files that reflect the solution, wherein the defined system module is configured to create graphs, tables, and analytical results to appear in the reports created.

8. The method of claim 1, wherein the software platform is configured to:
introduce a (*.btt) file format for modeling energy storage technologies, the (*.btt) file format is configured to allow users to accurately compare performance of different energy storage technologies running different applications, thereby allowing the user to select the most appropriate technology for their use-case and optimize designs;
introduce a (*.inv) file format for modeling energy storage inverters, the (*.inv) file format is configured to allow users to accurately compare performance of different inverter products, thereby leading to optimal equipment selection for user designs; or
introduce a (*.cnv) file format for modeling energy storage DC/DC converters, the (*.cnv) file format is configured to allow users to accurately compare performance of different converter products, thereby leading to optimal equipment selection for user designs.

9. The method of claim 8, wherein the software platform is configured to:
introduce a (*.btt) file format for modeling energy storage technologies, the (*.btt) file format is configured to allow users to accurately compare performance of different energy storage technologies running different applications, thereby allowing the user to select the most appropriate technology for their use-case and optimize designs;
introduce a (*.inv) file format for modeling energy storage inverters, the (*.inv) file format is configured to allow users to accurately compare performance of different inverter products, thereby leading to optimal equipment selection for user designs; and
introduce a (*.cnv) file format for modeling energy storage DC/DC converters, the (*.cnv) file format is configured to allow users to accurately compare performance of different converter products, thereby leading to optimal equipment selection for user designs.

10. The method of claim 1, wherein the software platform is designed and configured to:
aid and simplify the process of designing and sizing grid-tied and islanded energy storage systems;
allow users to easily deduce energy storage systems dispatch profiles POI profiles and simulate the performance of UDSs by executing the user defined POI profiles;
allow accurate estimation of energy storage system performance characteristics including, but not limited to, degradation, round-trip efficiency, losses, and auxiliary load requirements based on user inputted dispatch profiles, or ones developed within the software platform;
allow users to create models that accurately reflect the performance of OEM battery products when simulated inside the software platform;
allow users to create models that accurately reflect the performance of OEM bi-directional inverter products when simulated inside the software platform;
allow users to create models that accurately reflect the performance of OEM DC/DC converter products when simulated inside the software platform;
or combinations thereof.

11. The method of claim 1, wherein the software platform is designed and configured to:
allow users to accurately predict how energy storage systems will degrade prior to procurement from ESS OEMs well after the design phase;
allow users to compare between the performance of different Energy Storage (ES) technologies running the users specific application/use-case specific, which allows the user to select the most suitable Energy Storage Medium for their specific use-case, thereby leading to minimizing project cost and maximizing ESS life;
allow users to accurately deduce performance characteristics of Energy Storage (ES) technologies very early in the conception and design phase of grid-tied and islanded ES systems, which results in more accurate estimation of capital and operating cost of conceptualized battery system;
provide a standard model file format for Energy Storage Mediums that enables users to compare utilization of different ESMs for their projects;
allow users to easily deduce ESS dispatch profiles for different grid-tied and islanded systems' use-cases/applications, thereby preventing the user from needing to write lengthy code or spend hours writing excel formulas;
allow users to produce ESS dispatch profiles with multiple use-cases/applications stacked or prioritized based on user requirements, thereby enabling the user to use one ESS for more than one function leading to optimizing performance and maximizing financial revenue of designed energy storage projects;
allow users to model ESSs, simulate their performance and create dispatch profiles at variable interval data time-steps, thereby allowing the user to interval data with different time-steps, allowing much needed flexibility in the energy storage system design process, allowing interval data time-step to be as short as one (1) second;
allow users to model energy storage systems, simulate their performance and create dispatch profiles at extremely high fidelity, thereby allowing time-steps to be as short as one (1) second, wherein the method is configured to allow the produced results to be of the highest accuracy reflecting real energy storage system performance;
accurately estimate lithium and non-lithium battery technologies degradation throughout project life, considering impacts of Depth of Discharge, C-rate, Average State of Charge, Center State of Charge, Calendar Life, Ambient temperature, amongst other factors separately, thereby allowing users to optimize use-cases and performance;
accurately model energy storage projects' energy losses and round-trip efficiency during operation, considering ambient temperature, C-rate, battery cell specifications, type of cooling systems, project region, dispatch profile and other factors;
allow the user full flexibility in the energy storage design process by simplifying development of energy storage systems dispatch profiles and allowing the user to use these profiles directly to model the performance of the actual system;
or combinations thereof.

12. A method to aid in creating dispatch profiles for energy storage systems comprising:
providing a computer-readable software platform configured to store instructions that, when executed by a computer, cause the software platform to:
create a creator module (PCM) for the energy storage systems, the profile creator module is configured to develop energy storage system dispatch profiles for multiple utility, commercial and industrial (C&I), and residential applications use cases (ES Apps).

13. The method of claim 12, wherein:
the profile creator module including:
PCM User inputs;
a PCM Solution Development component; and
a PCM Results Creation component.

14. The method of claim 13, wherein:
the PCM User inputs are configured to allow the user to select and specify:
a Dispatch Mode;
the ES Apps;
a Simulation Time-step, duration and input profile templates to create;
input profiles for selected ES Apps;
ES App parameter values for each selected ES App;
a PCM Run Mode of a single run or a group run;
an option to use Deduced POI Profiles as input for DSM or not;
the PCM Solution Development component is designed and configured to:
allow the user to click a Run button;
check for errors in the PCM User Inputs, wherein if an error exists, the PCM Solution Development component is configured to alert the user to fix, and wherein if no errors exist, the PCM Solution Development component is configured to continue;
analyze the PCM user inputs;
optimize an ESS Profile based on the PCM User Inputs;
deduce a PCM Solution Data Set, and activate a Generate Report button, and a Generate Output CSVs button;
if the user opted to use the POI Profile Deduced from the profile creator module in the defined system module, create a POI profile file in an input directory for the defined system module;
the PCM Results Creation component is configured to:
allow the user to click a Generate Report button;
create PCM Report files in PDF format and save the PCM Report files in a user specified location;
open the created PCM Report files for user to visualize;
allow the user to click Generate Output CSVs button; and
create PCM CSV files in CSV format and save the created PCM CSV files in a user specified location.

15. The method of claim 14, wherein the energy storage system dispatch profiles developed by the profile creator module including Peak Load Shaving, Energy Arbitrage, Schedule Based Dispatch, Demand Charge Management, Renewables Smoothing, Renewables Firming, DC/AC Renewables Clipped/Curtailed Energy Storage, Daily Discharge & Charge Energy Equalization, Islanding Energy and Capacity Management, and Microgrid Operation.

16. The method of claim 15, wherein the profile creator module including a PCM interface configured to allow the user to input the PCM user inputs specific to multiple ES Apps;
wherein the PCM user inputs including a set of PCM parameters and CSV files;
wherein the profile creator module including a run button configured to simulate the performance of selected ES Apps, wherein the profile creator module is configured to produce an ESS dispatch profile, reports, and analytics that reflect user inputs;
wherein the produced dispatch profile is configured to be used as an input to a defined system module;
wherein the profile creator module is configured to allow the user to specify within the software platform how different ES Apps interact with each other by allowing them to be prioritized, stacked, or interact in another user-defined or pre-set method, wherein the profile creator module is configured to allow the user to set a user defined timestep and a duration for a simulation and for output results, wherein based on the user defined timestep and the duration of the simulation, the profile creator module is configured to produce template interval data CSV files configured to allow the user to input a dataset to be used with selected ES Apps, whereby, using these templates, the user can input load, photovoltaic (PV), wind, thermal plant, hydro-plant or other time-interval profiles and set PCM User Inputs to control how the energy storage dispatch profile will be deduced within the software based on this interval data;
wherein once the user is satisfied with files and data inputted, the profile creator module is configured to either run in a single run mode configured for if the user wanted to simulate only one case, or a group run mode configured for if the user wanted to run a group of simulations to find the optimal result, wherein the user can opt to use a created dispatch profile as the input to the defined system module; and
wherein after running the simulation, the profile creator module is configured to create reports, graphs, tables, and CSV files that reflect the solution and all associated analytics, wherein the profile creator module is also configured to customize graphs, tables and analytical results that appear in the reports created.

17. A method to aid in modeling performance of energy storage systems comprising:
providing a computer-readable software platform configured to store instructions that, when executed by a computer, cause the software platform to:
create a system defined system module (DSM) for the energy storage systems, the defined system module is configured to allow a user to deduce performance metrics for a user-defined Energy Storage System (ESS) by executing a user-defined POI Profile deduced by the user or developed through a profile creator module, wherein the defined system module is configured to deduce parameters that allow the user to optimize the design of the energy storage system for a specific ES App.

18. The method of claim 17, wherein:
the defined system module including:
DSM User Inputs;
a DSM Simulation component; and
a DSM Results Creation component.

19. The method of claim 18, wherein:
the DSM User Inputs are configured to allow the user to select and specify:
a POI Profile, which is either user developed or output from the profile creator module;
a Typical Meteorological Year (TMY) data file in (*.csv) format, which is either user developed or sourced from a third-party;
to create new or edit existing equipment models using a component editor;
equipment models for a user defined system (UDS);
system specifications for the UDS, the system specifications including equipment count, and architecture;
a sizing assist continuously updates and shows UDS parameters and compares with those needed by the POI profile;
ESS Operational Parameters;
ESS Degradation Estimation Assumptions for the UDS
a DSM Run Mode including a single run or a group run;
the DSM Simulation component is designed and configured to:
allow the user to click a Run button;
check for errors in the DSM User inputs or incompatibilities in the UDS, wherein, if any errors exist, the DSM Solution Development component is configured to alert the user to fix, and wherein if no errors exist, the DSM Solution Development component is configured to continue;
analyzes the DSM User Inputs;
deduces all ESS States during execution of the POI Profile with the UDS;
deduces a DSM Solution Data Set, and activates the Generate Report and the Generate Output CSVs buttons;
the DSM Results Creation component is designed and configured to:
allow the user to click the Generate Report button;
create DSM Report files in PDF format and saves the DSM Report files in the user specified location;
open created DSM Report files for the user to visualize;
allow the user to click the Generate Output CSVs button; and
create DSM CSV files in CSV format and saves the DSM CSV files in the user specified location.

20. The method of claim 19, wherein the parameters deduced by the defined system module including system energy losses, efficiency, battery degradation estimates, throughput, depth of discharge, C-rate, average State of Charge (SoC), and many other parameters that allow the user to optimize the design of the energy storage system for specific ES Apps;
wherein the defined system module includes a DSM interface configured to allow the user to input user inputs that describe a user specified energy storage system and how it will be operated, wherein the user inputs including a set of parameters and files;
wherein the defined system module is configured to allow the user to input the user defined POI Profile that represents how the energy storage system will be dispatched controlled, where the user defined POI Profile is either developed within the profile creator module or self-deducted by the user;
wherein the defined system module is configured to allow the user to select models of equipment that will be utilized in the energy storage system, wherein the models of equipment can be selected from a library of default models provided within the defined system module, or the models of equipment can be created by the user using a software component editor;
wherein the equipment including energy storage mediums, batteries, inverters, converters, transformers, energy storage enclosures, and cables;
wherein after selecting the models of equipment, the defined system module is configured to allow the user to define specifications, architecture and topology of the energy storage system, and wherein, as the user defines the specifications, the architecture and the topology, a sizing assist tool is configured to show the user how the energy storage system specified compares in capacity, energy, voltage, power, and current to the requirements of the user defined POI Profile, wherein the sizing assist tool is configured to show the user compatibility of devices specified or lack thereof, and wherein, the defined system module is also configured to allow the user to specify operational requirements of the contemplated energy storage system and state of health and degradation parameters to be assumed in the simulation; and
wherein the defined system module is configured to allow the user to run the simulation to deduce critical information about the performance of the user defined system, wherein the defined system module is configured to allow the user to run the simulation in a single run mode configured to simulate only one case, or to allow the user to run the simulation in a group run mode configured to run a group of simulations to find an optimal result, wherein, after running the simulation, the defined system module is configured to allow the user to create reports, graphs, tables and CSV files that reflect the solution, wherein the defined system module is configured to create graphs, tables, and analytical results to appear in the reports created.
